(19) United States
(12) Patent Application Publication
(10) Pub. No.: US 2007/0080967 A1
(43) Pub. Date: Apr. 12, 2007

(54) Generation of normalized 2D imagery and ID systems via 2D to 3D lifting of multifeatured objects

(75) Inventor: Michael I. Miller, Jackson, NH (US)

Correspondence Address: WILMER CUTLER PICKERING HALE AND DORR LLP, 60 STATE STREET, BOSTON, MA, 02109, US

(73) Assignee: Animetrics Inc., Jackson, NH (US)

(21) Appl. No.: 11/482,242

(22) Filed: Jun. 29, 2006

Related U.S. Application Data
(60) Provisional application No. 60/725,251, filed on Oct. 11, 2005.

(51) Int. Cl. G06T 15/70; G06T 13/00

(52) U.S. Cl. 345/473

(57) ABSTRACT

A method of generating a normalized image of a target head from at least one source 2D image of the head. The method involves estimating a 3D shape of the target head and projecting the estimated 3D target head shape lit by normalized lighting into an image plane corresponding to a normalized pose. The estimation of the 3D shape of the target involves searching a library of 3D avatar models, and may include matching unlabeled feature points in the source image to feature points in the models, and the use of a head's plane of symmetry. Normalizing source imagery before providing it as input to traditional 2D identification systems enhances such systems' accuracy and allows systems to operate effectively with oblique poses and non-standard source lighting conditions.

### CROSS-REFERENCE TO RELATED APPLICATIONS

This application claims priority to U.S. Provisional Patent Application Ser. No. 60/725,251, filed Oct. 11, 2005, which is incorporated herein by reference.

### TECHNICAL FIELD

This invention relates to object modeling and identification systems, and more particularly to the determination of 3D geometry and lighting of an object from 2D input using 3D models of candidate objects.

### BACKGROUND

Facial identification (ID) systems typically function by attempting to match a newly captured image with an image that is archived in an image database. If the match is close enough, the system determines that a successful identification has been made. The matching takes place entirely within two dimensions, with the ID system manipulating both the captured image and the database images in 2D.

Most facial image databases store pictures that were captured under controlled conditions in which the subject is captured in a standard pose and under standard lighting conditions. Typically, the standard pose is a head-on pose, and the standard lighting is neutral and uniform. When a newly captured image to be identified is obtained with a standard pose and under standard lighting conditions, it is normally possible to obtain a relatively close match between the image and a corresponding database image, if one is present in the database. However, such systems tend to become unreliable as the image to be identified is captured under pose and lighting conditions that deviate from the standard pose and lighting. This is to be expected, because both changes in pose and changes in lighting will have a major impact on a 2D image of a three-dimensional object, such as a face.

### SUMMARY

Embodiments described herein employ a variety of methods to “normalize” captured facial imagery (both 2D and 3D) by means of 3D avatar representations so as to improve the performance of traditional ID systems that use a database of images captured under standard pose and lighting conditions. The techniques described can be viewed as providing a “front end” to a traditional ID system, in which an available image to be identified is preprocessed before being passed to the ID system for identification. The techniques can also be integrated within an ID system that uses 3D imagery, or a combination of 2D and 3D imagery.

The methods exploit the lifting of 2D photometric and geometric information to 3D coordinate system representations, referred to herein as avatars or model geometry. As used herein, the term lifting is taken to mean the estimation of 3D information about an object based on one or more available 2D projections (images) and/or 3D measurements. Photometric lifting is taken to mean the estimation of 3D lighting information based on the available 2D and/or 3D information, and geometric lifting is taken to mean the estimation of 3D geometrical (shape) information based on the available 2D and/or 3D information.

The construction of the 3D geometry from 2D photographs involves the use of a library of 3D avatars. The system calculates the closest matching avatar in the library of avatars. It may then alter 3D geometry, shaping it to more closely correspond to the measured geometry in the image. Photometric (lighting) information is then placed upon this 3D geometry in a manner that is consistent with the information in the image plane. In other words, the avatar is lit in such a way that a camera in the image plane would produce a photograph that approximates to the available 2D image.

When used as a preprocessor for a traditional 2D ID system, the 3D geometry can be normalized geometrically and photometrically so that the 3D geometry appears to be in a standard pose and lit with standard lighting. The resulting normalized image is then passed to the traditional ID system for identification. Since the traditional ID system is now attempting to match an image that has effectively been rotated and photometrically normalized to place it in correspondence with the standard images in the image database, the system should work effectively, and produce an accurate identification. This preprocessing serves to make traditional ID systems robust to variations in pose and lighting conditions. The described embodiment also works effectively with 3D matching systems, since it enables normalization of the state of the avatar model so that it can be directly and efficiently compared to standardized registered individuals in a 3D database.

In general, in one aspect, the invention features a method of estimating a 3D shape of a target head from at least one source 2D image of the head. The method involves searching a library of candidate 3D avatar models to locate a best-fit 3D avatar, for each 3D avatar model among the library of 3D avatar models computing a measure of fit between a 2D projection of that 3D avatar model and the at least one source 2D image, the measure of fit being based on at least one of (i) unlabeled feature points in the source 2D imagery, and (ii) additional feature points generated by imposing symmetry constraints, wherein the best-fit 3D avatar is the 3D avatar model among the library of 3D avatar models that yields a best measure of fit and wherein the estimate of the 3D shape of the target head is derived from the best-fit 3D avatar.

Other embodiments include one or more of the following features. A target image illumination is estimated by generating a set of notional lightings of the best-fit 3D avatar and searching among the notional lightings of the best-fit avatar to locate a best notional lighting that has a 2D projection that yields a best measure of fit to the target image. The notional lightings include a set of photometric basis functions and at least one of small and large variations from the basis functions. The best-fit 3D avatar is projected and compared to a gallery of facial images, and identified with a member of the gallery if the fit exceeds a certain value. The search among avatars also includes searching at least one of small and large deformations of members of the library of avatars. The estimation of 3D shape of a target head can be made from a single 2D image if the surface texture of the target head is known, or if symmetry constraints on the avatar and source image are imposed. The estimation of 3D shape of a target head can be made from two or more 2D images even if the surface texture of the target head is initially unknown.

In general, in another aspect, the invention features a method of generating a normalized 3D representation of a target head from at least one source 2D projection of the head. The method involves providing a library of candidate 3D avatar models, and searching among the candidate 3D avatar models and their deformations to locate a best-fit 3D avatar, the searching including, for each 3D avatar model among the library of 3D avatar models and each of its deformations, computing a measure of fit between a 2D projection of that deformed 3D avatar model and the at least one source 2D image, the deformations corresponding to permanent and non-permanent features of the target head, wherein the best-fit deformed 3D avatar is the deformed 3D avatar model that yields a best measure of fit; and generating a geometrically normalized 3D representation of the target head from the best-fit deformed 3D avatar by removing deformations corresponding to non-permanent features of the target head.

Other embodiments include one or more of the following features. The normalized 3D representation is projected into a plane corresponding to a normalized pose, such as a face-on view, to generate a geometrically normalized image. The normalized image is compared to members of a gallery of 2D facial images having a normal pose, and positively identified with a member of the gallery if a measure of fit between the normalized image and a gallery member exceeds a predetermined threshold. The best-fitting avatar can be lit with normalized (such as uniform and diffuse) lighting before being projected into a normal pose so as to generate a geometrically and photometrically normalized image.

In general, in yet another aspect, the invention features a method of estimating the 3D shape of a target head from source 3D feature points. The method involves searching a library of avatars and their deformations to locate the deformed avatar having the best fit to the 3D feature points, and basing the estimate on the best-fit avatar.

Other embodiments include matching to avatar feature points and their reflections in an avatar plane of symmetry, using unlabeled source 3D feature points, and using source 3D normal feature points that specify a head surface normal direction as well as position. Comparing the best-fit deformed avatar with each gallery member, yields a positive identification of the 3D head with a member of a gallery of 3D reference representations of heads if a measure of fit exceeds a predetermined threshold.

In general, in still another aspect, the invention features a method of estimating a 3D shape of a target head from a comparison of a projection of a 3D avatar and dense imagery of at least one source 2D image of a head.

In general, in a further aspect, the invention features positively identifying at least one source image of a target head with a member of a database of candidate facial images. The method involves generating a 3D avatar corresponding to the source imagery and generating a 3D avatar corresponding to each member of the database of candidate facial images using the methods described above. The target head is positively identified with a member of the database of candidate facial images if a measure of fit between the source avatar corresponding to the source imagery and an avatar corresponding to a candidate facial image exceeds a predetermined threshold.

### BRIEF DESCRIPTION OF THE DRAWINGS

FIG. 1 is a flow diagram illustrating the principal steps involved in normalizing a source 2D facial image.

FIG. 2 illustrates photometric normalization of a source 2D facial image.

FIG. 3 illustrates geometric normalization of a source 2D facial image.

FIG. 4 illustrates performing both photometric and geometric normalization of a source 2D facial image.

FIG. 5 illustrates removing lighting variations by spatial filtering and symmetrization of source facial imagery.

### DETAILED DESCRIPTION

A traditional photographic ID system attempts to match one or more target images of the person to be identified with an image in an image library. Such systems perform the matching in 2D using image comparison methods that are well known in the art. If the target images are captured under controlled conditions, the system will normally identify a match, if one exists, with an image in its database because the system is comparing like with like, i.e., comparing two images that were captured under similar conditions. The conditions in question refer principally to the pose and shape of the subject and the photometric lighting. However, it is often not possible to capture target photographs under controlled conditions. For example, a target image might be captured by a security camera without the subject's knowledge, or it might be taken while the subject is fleeing the scene.

The described embodiment converts target 2D imagery captured under uncontrolled conditions in the projective plane and converts it into a 3D avatar geometry model representation. Using the terms employed herein, the system lifts the photometric and geometric information from 2D imagery or 3D measurements onto the 3D avatar geometry. It then uses the 3D avatar to generate geometrically and photometrically normalized representations that correspond to standard conditions under which the reference image database was captured. These standard conditions, also referred to as normal conditions, usually correspond to a head-on view of the face with a normal expression and neutral and uniform illumination. Once a target image is normalized, a traditional ID system can use it to perform a reliable identification.

Since the described embodiment can normalize an image to match a traditional ID system's normal pose and lighting conditions exactly, the methods described herein also serve to increase the accuracy of a traditional ID system even when working with target images that were previously considered close enough to “normal” to be suitable for ID via such systems. For example, a traditional ID system might have a 70% chance of performing an accurate ID with a target image pose of 30° from head-on. However, if the target is preprocessed and normalized before being passed to the ID system, the chance of performing an accurate ID might increase to 90%.

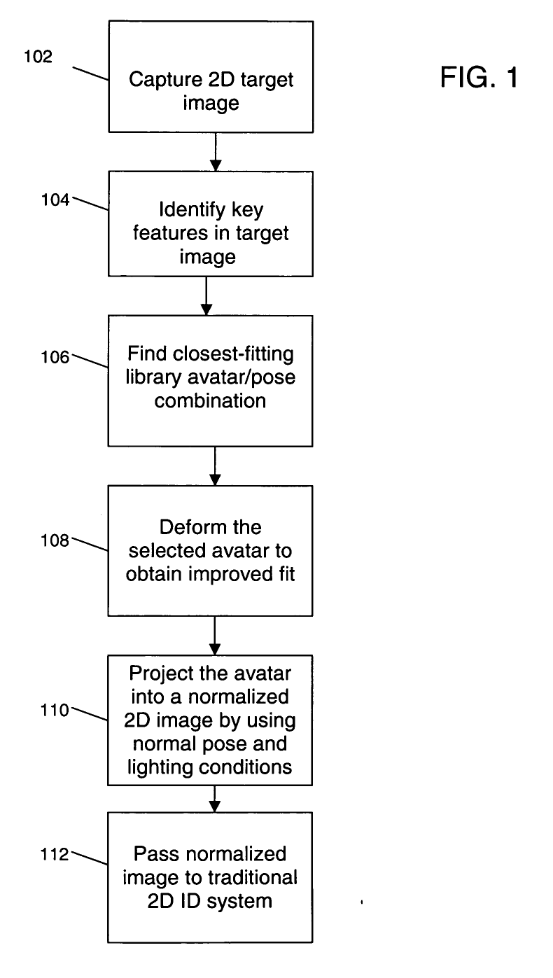

The basic steps of the normalization process are illustrated in FIG. 1. The target image is captured (102) under unknown pose and lighting conditions. The following steps (104-110) are described in detail in U.S. patent application Ser. Nos. 10/794,353 and 10/794,943, which are incorporated herein in their entirety.

The process starts with a process called jump detection, in which the system scans the target image to detect the presence of the feature points whose existence in the image plane are substantially invariant across different faces under varying lighting conditions and under varying poses (104). Such features include one or more of the following: points, such as the extremity of the mouth, curves, such an eyebrow; brightness order relationships; image gradients; edges, and subareas. For example, the existence in the image plane of the inside and outside of a nostril is substantially invariant under face, pose, and lighting variations. To determine the lifted geometry, the system only needs about 3-100 feature points. Each identified feature point corresponds to a labeled feature point in the avatar. Feature points are referred to as labeled when the correspondence is known, and unlabeled when the correspondence is unknown.

Since the labeled feature points being detected are a sparse sampling of the image plane and relatively small in number, jump detection is very rapid, and can be performed in real time. This is especially useful when a moving image is being tracked.

The system uses the detected feature points to determine the lifted geometry by searching a library of avatars to locate the avatar whose invariant features, when projected into 2D at all possible poses, has a projection which yields the closest match to the invariant features identified in the target imagery (106). The 3D lifted avatar geometry is then refined via shape deformation to improve the feature correspondence (108). This 3D avatar representation may also be refined via unlabeled feature points, as well as dense imagery requiring diffusion or gradient matching along with the sparse landmark-based matching, and 3D labeled and unlabeled features.

In subsequent step 110, the deformed avatar is lit with the normal lighting parameters and projected into 2D from an angle that corresponds to the normal pose. The resulting “normalized” image is passed to the traditional ID system (112). Aspects of these steps that relate to the normalization process are described in detail below.

The described embodiment performs two kinds of normalization: geometric and photometric. Geometric normalizations include the normalization of pose, as referred to above. This corresponds to rigid body motions of the selected avatar. For example, a target image that was captured from 30° clockwise from head-on has its geometry and photometry lifted to the 3D avatar geometry, from which it is normalized to a head-on view by rotating the 3D avatar geometry by 30° anti-clockwise before projecting it into the image plane.

Geometric normalizations also include shape changes, such as facial expressions. For example, an elongated or open mouth corresponding to a smile or laugh can be normalized to a normal width, closed mouth. Such expressions are modeled by deforming the avatar so as to obtain an improved key feature match in the 2D target image (step 108). The system later “backs out” or “inverts” the deformations corresponding to the expressions so as to produce an image that has a “normal” expression. Another example of shape change corresponding to geometric normalization inverts the effects of aging. A target image of an older person can be normalized to the corresponding younger face.

Photometric normalization includes lighting normalizations and surface texture/color normalizations. Lighting normalization involves converting a target image taken under non-standard illumination and converting it to normal illumination. For example, a target image may be lit with a point source of red light. Photometric normalization converts the image into one that appears to be taken under neutral, uniform lighting. This is performed by illuminating the selected deformed avatar with the standard lighting before projecting it into 2D (110).

A second type of photometric normalization takes account of changes in the surface texture or color of the target image compared to the reference image. An avatar surface is described by a set of normals N(x) which are 3D vectors representing the orientations of the faces of the model, and a reference texture called T_{ref}(x), that is a data structure, such as a matrix having an RGB value for each polygon on the avatar. Photometric normalization can involve changing the values of T_{ref} for some of the polygons that correspond to non-standard features in the target image. For example, a beard can change the color of a region of the face from white to black. In the idealized case, this would correspond to the RGB values changing from (256, 256, 256) for white to (0,0,0) for black. In this case, photometric normalization corresponds to restoring the face to a standard, usually with no facial hair.

As illustrated by 108 in FIG. 1, the selected avatar is deformed prior to illumination and projection into 2D. Deformation denotes a variation in shape from the library avatar to a deformed avatar whose key features more closely correspond to the key features of the target image. Deformations may correspond to an overall head shape variation, or to a particular feature of a face, such as the size of the nose.

The normalization process distinguishes between small geometric or photometric changes performed on the library avatar and large changes. A small change is one in which the geometric change (be it a shape change or deformation) or photometric change (be it a lighting change to surface texture/color change) is such that the mapping from the library avatar to the changed avatar is approximately linear. Geometric transformation moves the coordinates according to the general mapping x∈ R³ [symbol] φ(x)∈ R³. For small geometric transformation, the mapping approximates to an additive linear change in coordinates, so that the original value x maps approximately under the linear relationship x ∈ R³ [symbol] φ(x)≈x+u(x) ∈ R³. The lighting variation changes the values of the avatar function texture field values T(x) at each coordinate systems point x, and is generally of the multiplicative form

$${T}_{ref} ( x ) ↦ \underbrace{{e}^{ψ ( x )}}_{L ( x )} \cdot {T}_{ref} ( x ) ∈ {ℝ}^{3} .$$

For small variation lighting the change is also linearly approximated by
T_{ref}(x) [symbol] L(x)·T_{ref}(x)≈ε(x)+T_{ref}(x) ∈ R³.

Examples of small geometric deformations include small variations in face shape that characterize a range of individuals of broadly similar features and the effects of aging. Examples of small photometric changes include small changes in lighting between the target image and the normal lighting, and small texture changes, such as variations in skin color, for example a suntan. Large deformations refer to changes in geometric or photometric data that are large enough so that the linear approximations used above for small deformations cannot be used.

Examples of large geometric deformations include large variation in face shapes, such as a large nose compared to a small nose, and pronounced facial expressions, such as a laugh or display of surprise. Examples of large photometric changes include major lighting changes such as extreme shadows, and change from indoor lighting to outdoor lighting.

The avatar model geometry, from here on referred to as a CAD model (or by the symbol CAD) is represented by a mesh of points in 3D that are the vertices of the set of triangular polygons that approximate the surface of the avatar. Each surface point x ∈ CAD has a normal direction N(x) ∈ R³, x ∈ CAD. Each vertex is given a color value, called a texture T(x) ∈ R³, x ∈ CAD, and each triangular face is colored according to an average of the color values assigned to its vertices. The color values are determined from a 2D texture map that may be derived using standard texture mapping procedures, which define a bijective correspondence (1-1 and onto) from the photograph used to create the reference avatar. The avatar is associated with a coordinate system that is fixed to it, and is indexed by three angular degrees of freedom (pitch, roll, and yaw), and three translational degrees of freedom of the rigid body center in three-space. To capture articulation of the avatar geometry, such as motion of the chin and eyes, certain subparts have their own local coordinates, which form part of the avatar description. For example, the chin can be described by cylindrical coordinates about an axis corresponding to the jaw. Texture values are represented by a color representation, such RGB values. The avatar vertices are connected to form polygonal (usually triangular) facets.

Generating a normalized image from a single or multiple target photographs requires a bijection or correspondence between the planar coordinates of the target imagery and the 3D avatar geometry. As introduced above, once the correspondences are found, the photometric and geometric information in the measured imagery can be lifted onto the 3D avatar geometry. The 3D object is manipulated and normalized, and normalized output imagery is generated from the 3D object. Normalized output imagery may be provided via OpenGL or other conventional rendering engines, or other rendering devices. Geometric and photometric lifting and normalization are now described.

2D to 3D Photometric Lifting to 3D Avatar Geometries

Nonlinear Least-Square Photometric Lifting

For photometric lifting, it is assumed that the 3D model avatar geometry with surface vertices and normals is known, along with the avatar's shape and pose parameters, and its reference texture T_{ref}(x), x ∈ CAD. The lighting normalization involves the interaction of the known shape and normals on the surface of the CAD model. The photometric basis is defined relative to the midplane of the avatar geometry and the interaction of the normals indexed with the surface geometry and the luminance function representation. Generating a normalized image from a single or multiple target photographs requires a bijection or correspondence between the planar coordinates of the imagery I(p), p ∈ [0,1]² and the 3D avatar geometry, denoted p ∈ [0,1]²⇄x(p) ∈ R³; for the correspondence between the multiple views I^{v}(p),v=1, . . . , V, the multiple correspondences becomes p ∈ [0,1]²⇄x^{v}(p) ∈ R³. A set of photometric basis functions representing the entire lighting sphere for each I^{v}(p) is computed in order to represent the lighting of each avatar corresponding to the photograph, using principal components relative to the particular geometric avatars. The photometric variation is lifted onto the 3D avatar geometry by varying the photometric basis functions representing illumination variability to match optimally the photographic values between the known avatar and the photographs. By working in the log-coordinates, the luminance function, L(x), x ∈ CAD, can be estimated in a closed-form least-squares solution for the photometric basis functions. The color of the illuminating light can also be normalized by matching the RGB values in the textured representation of the avatar to reflect lighting spectrum variations, such as natural versus artificial light, and other physical characteristics of the lighting source.

Once the lighting state has been fit to the avatar geometry, neutralized, or normalized versions of the textured avatar can be generated by applying the inverse transformation specified by the geometric and lighting features to the best-fit models. The system then uses the normalized avatar to generate normalized photographic output in the projective plane corresponding to any desired geometric or lighting specification. As mentioned above, the desired normalized output usually corresponds to a head-on pose viewed under neutral, uniform lighting.

Photometric normalization is now described via the mathematical equations which describe the optimum solution. Given a reference avatar texture field, the textured lighting field T(x),x ∈ CAD is written as a perturbation of the original reference T_{ref}(x), x ∈ CAD by luminance L(x), x ∈ CAD and color functions e^{t}^{_{R}}, e^{t}^{_{G}}, e^{t}^{_{B}}. These luminance and color functions can in general be expanded in a basis which may be computed using principal components on the CAD model by varying all possible illuminations. It may sometimes be preferable to perform the calculation analytically based on any other complete orthonormal basis defined on surfaces, such as spherical harmonics, Laplace-Beltrami functions and other functions of the derivatives. In general, luminance variations cannot be additive, as the space of measured imagery is a positive function space. For representing large variation lighting, the photometric field T(x) is modeled as a multiplicative group acting on the reference textured object T_{ref} according to

$$L : {T}_{ref} ( x ) ↦ T ( x ) = L ( x ) \cdot {T}_{ref} ( x ) = ( {L}^{R} ( x ) \cdot {T}_{ref}^{R} ( x ) , {L}^{G} ( x ) \cdot {T}_{ref}^{G} ( x ) , {L}^{B} ( x ) \cdot {T}_{ref}^{B} ( x ) ) = ( \underbrace{{ⅇ}^{{\sum }_{i = 1}^{d} {l}_{i}^{R} {ϕ}_{i} ( x )}}_{{L}^{R} ( x )} {T}_{ref}^{R} ( x ) , \underbrace{{ⅇ}^{{\sum }_{i = 1}^{d} {l}_{i}^{G} {ϕ}_{i} ( x )}}_{{L}^{G} ( x )} {T}_{ref}^{G} ( x ) , \underbrace{{ⅇ}^{{\sum }_{i = 1}^{d} {l}_{i}^{B} {ϕ}_{i} ( x )}}_{{L}^{B} ( x )} {T}_{ref}^{B} ( x ) ) \qquad ( 1 )$$

where φᵢ are orthogonal basis functions indexed over the face, and the coefficient vectors l₁=(l₁^{R}, l₁^{G}, l₁^{B}),l₂=(l₂^{R}, l₂^{G}, l₂^{B}), . . . represent the unknown basis function coefficients representing a different variation for each RGB within the multiplicative representation.

Here L(·) represents the luminance function indexed over the CAD model resulting from interaction of the incident light with the normal directions of the 3D avatar surface. Once the correspondence is defined between the observed photograph and the avatar representation p ∈ [0,1]²⇄x(p) ∈ R³, there exists a correspondence between the photograph and the RGB texture values on the avatar. In this section it is assumed that the avatar texture T_{ref}(x) is known. In general, the overall color spectrum of the texture field may demonstrate variations as well. In this case, each RGB expansion coefficient solves for the separate channel random field variations requires solution of the minimum mean-squared error (MMSE) equations

$${min}_{{l}_{1}^{R} , {l}_{1}^{G} , {l}_{1}^{B} …} {\sum }_{p ∈ {[ 0 , 1 ]}^{2}} {\sum }_{c = R , G , B} {( {I}^{c} ( p ) = {L}^{c} ( \cdot ) {T}^{c} ( \cdot ) ( x ( p ) ) )}^{2} . \qquad ( 2 )$$

The system then uses non-linear least-squares algorithms such as gradient algorithms or Newton search to generate the minimum mean-squared error (MMSE) estimator of the lighting field parameters. It does this by solving the minimization over the luminance fields in the span of the bases

$${L}^{c} = {ⅇ}^{{\sum }_{i = 1}^{d} {l}_{i}^{c} {ϕ}_{i} ( x )} , c = R , G , B .$$

Other norms besides the 2-norm for positive functions may be used, including the Kullback-Liebler distance, L1 distance, or others. Correlation between the RGB components can be introduced via a covariance matrix between the lighting and color components.

For a lower-dimensional representation in which there is a single RGB tinting function—rather than one for each expansion coefficient—the model becomes simply

$$T ( x ) {ⅇ}^{{\sum }_{i = 1}^{d} {l}_{i} {ϕ}_{i} ( x )} ( {ⅇ}^{{t}_{R}} {T}_{ref}^{R} ( x ) , {ⅇ}^{{t}_{G}} {T}_{ref}^{G} ( x ) , {ⅇ}^{{t}_{B}} {T}_{ref}^{B} ( x ) ) .$$

The MMSE corresponds to

$${min}_{{t}_{R} , {t}_{G} , {t}_{B} , {l}_{1} , {l}_{2} …} {\sum }_{p ∈ {[ 0 , 1 ]}^{2}} {\sum }_{c = R , G , B} {( {I}^{c} ( p ) - {ⅇ}^{{t}_{c} + {\sum }_{i = 1}^{d} {l}_{i} {ϕ}_{i} ( x )} {T}_{ref}^{c} ( x ( p ) ) )}^{2} . \qquad ( 3 )$$

Given the reference T_{ref}(x), the non-linear least-squares algorithms such as gradient algorithms and Newton search, can be used for minimizing the least-squares equation.

Fast Photometric Lifting to 3D Geometries via the Log Metric

Since the space of lighting variations is very extensive, multiplicative photometric normalization is computationally intensive. A log transformation creates a robust, computationally effective, linear least-squares formulation. Converting the multiplicative group to an additive representation by working in the logarithm gives

$$log \frac{{T}^{c} ( x )}{{T}_{ref}^{c} ( x )} = {\sum }_{i = 1}^{d} {l}_{i}^{c} {ϕ}_{i} ( x ) , \\ c = R , G , B ;$$

the resulting linear least-squares error (LLSE) minimization problem in logarithmic representation becomes

$${min}_{{l}_{1}^{R} , {l}_{1}^{G} , {l}_{1}^{B} …} {\sum }_{c = R , G , B} {\sum }_{p ∈ {[ 0 , 1 ]}^{2}} {( log \frac{{I}^{c} ( p )}{{T}_{ref}^{c} ( x ( p ) )} - {\sum }_{i = 1}^{d} {l}_{i}^{c} {ϕ}_{i} ( x ( p ) ) )}^{2} . \qquad ( 4 )$$

Optimizing with respect to each of the coefficients gives the LLSE equations for each coefficient for lⱼ=(lⱼ^{R},lⱼ^{G},lⱼ^{B}), j=1, . . . , d:,

$$for \\ c = R , G , B , \\ j = 1 , … , d \\ {\sum }_{p ∈ {[ 0 , 1 ]}^{2}} ( log \frac{{I}^{c} ( p )}{{T}_{ref}^{c} ( x ( p ) )} ) {ϕ}_{j} ( x ( p ) ) = {\sum }_{i = l}^{d} {l}_{i}^{c} {\sum }_{p {ε [ 0 , 1 ]}^{2}} {ϕ}_{i} ( x ( p ) ) {ϕ}_{j} ( x ( p ) ) . \\ \qquad ( 5 )$$

For large variation lighting in which there is an RGB tinting function and a single set of lighting expansion coefficients, the model becomes

$$T ( x ) = {ⅇ}^{{\sum }_{i = 1}^{d} {l}_{i} {ϕ}_{i} ( x )} ( {ⅇ}^{{t}_{R}} {T}_{ref}^{R} ( x ) , {ⅇ}^{{t}_{G}} {T}_{ref}^{G} ( x ) , {ⅇ}^{{t}_{B}} {T}_{ref}^{B} ( x ) ) .$$

Converting the multiplicative group to an additive representation via logarithm gives the LLSE in logarithmic representation:

$${min}_{{t}^{R} , {t}^{G} , {t}^{B} , {l}_{i …}} {\sum }_{c = R , G , B} {\sum }_{p ∈ {[ 0 , 1 ]}^{2}} {( log \frac{{I}^{c} ( p )}{{T}_{ref}^{c} ( x ( p ) )} - {t}_{c} - {\sum }_{i = 1}^{d} {l}_{i} {ϕ}_{i} ( x ( p ) ) )}^{2} . \qquad ( 6 )$$

Assuming the basis functions are normalized and the constant components of the fields are in the tinting color functions,

$${\sum }_{p ∈ {[ 0 , 1 ]}^{2}} ϕ ( x ( p ) ) = 0$$

for the basis functions, then the LLSE for the color tints becomes

$$for \\ c = R , G , B \\ {t}_{c} = ( \frac{1}{{\sum }_{p ∈ {[ 0 , 1 ]}^{2}} 1} ) ( {\sum }_{p ∈ {[ 0 , 1 ]}^{2}} log \frac{{I}^{c} ( p )}{{T}_{ref}^{c} ( x ( p ) )} ) . \qquad ( 7 )$$

The LSE's for the lighting functions becomes for j=1, . . . , d

$${\sum }_{p ∈ {[ 0 , 1 ]}^{2}} ( {\sum }_{c = R , G , B} log \frac{{I}^{c} ( p )}{{T}_{ref}^{c} ( x ( p ) )} - {t}_{c} ) {ϕ}_{j} ( x ( p ) ) = {\sum }_{i = 1}^{d} {l}_{i} {\sum }_{p ∈ {[ 0 , 1 ]}^{2}} {ϕ}_{i} ( x ( p ) ) {ϕ}_{j} ( x ( p ) ) . \qquad ( 8 )$$

Small Variation Photometric Lifting to 3D Geometries

As discussed above, small variations in the texture field (corresponding, for example, to small color changes of the reference avatar) are approximately linear T_{ref}(x) [symbol] ε(x)+T_{ref}(x), with the additive field modeled in the basis

$$ɛ ( x ) = {\sum }_{i = 1}^{d} ( {ɛ}_{i}^{r} , {ɛ}_{i}^{g} , {ɛ}_{i}^{b} ) {ϕ}_{i} ( x ) .$$

For small photometric variations, the MMSE satisfies

$${min}_{{ɛ}_{1}^{r} , {ɛ}_{1}^{g} , {ɛ}_{1}^{b} …} {\sum }_{p ∈ {[ 0 , 1 ]}^{2}} {\sum }_{c = R , G , B} {( {I}^{c} ( p ) - {T}_{ref}^{c} ( x ( p ) ) - {\sum }_{i = 1}^{d} {ɛ}_{i}^{c} {ϕ}_{i} ( x ( p ) ) )}^{2} \qquad ( 9 )$$

The LLSE's for the images directly (rather than their log) gives

$$for \begin{matrix}c = R , G , B , \\ j = 1 , … , d\end{matrix} \\ {\sum }_{p ∈ {[ 0 , 1 ]}^{2}} ( {I}^{c} ( p ) - {T}_{ref}^{c} ( x ( p ) ) ) {ϕ}_{j} ( x ( p ) ) = {\sum }_{i = 1}^{d} {ɛ}_{i}^{c} {\sum }_{p ∈ {[ 0 , 1 ]}^{2}} {ϕ}_{i} ( x ( p ) ) {ϕ}_{j} ( x ( p ) ) \qquad ( 10 )$$

Adding the color representation via the tinting function gives

$$ɛ ( x ) = {\sum }_{i = 1}^{d} ( {t}^{R} + {ɛ}_{i} , {t}^{G} + {ɛ}_{i} , {t}^{B} + {ɛ}_{i} ) {ϕ}_{i} ( x )$$

gives the color tints according to

$$for \\ c = R , G , B \\ ( \frac{1}{{\sum }_{p ∈ {[ 0 , 1 ]}^{2}} 1} ) ( {\sum }_{p ∈ {[ 0 , 1 ]}^{2}} {I}^{c} ( p ) - {T}_{ref}^{c} ( x ( p ) ) ) . \qquad ( 11 )$$

The LSE's for the lighting functions becomes

$$for \begin{matrix}c = R , G , B , \\ j = 1 , … , d\end{matrix} \\ {\sum }_{p ∈ {[ 0 , 1 ]}^{2}} ( {\sum }_{c = R , G , B} {I}^{c} ( p ) - {t}_{c} ) {ϕ}_{j} ( x ( p ) ) = {\sum }_{i = 1}^{d} {l}_{i}^{c} {\sum }_{p ∈ {[ 0 , 1 ]}^{2}} {ϕ}_{i} ( x ( p ) ) {ϕ}_{j} ( x ( p ) ) . \qquad ( 12 )$$

Photometric Lifting Adding Empirical Training Information

For all real-world applications databases that are representative of the application are available. These databases often play the role of being used as “training data.” information that is encapsulated and injected into the algorithms. The training data comes often in the forms of annotated pictures in which there is geometrically annotated information as well as photometrically annotated information. Here we describe the collection of annotated training databases that are collected in different lighting environments and therefore provide statistics that are representative of those lighting environments.

For all the photometric solutions, a prior distribution on the expansion coefficient in terms of a quadratic form representing the correlations of the scalars and vectors can be straightforwardly added based on the empirical representation from training sequences representing the range and method of variation of the features. Constructing covariances from empirical training sequences from estimated lighting functions provides the mechanism for imputing constraints. For this, the procedure is as follows. Given a training data set, Iₙ^{train}, n=1, 2 . . . , calculate the set of coefficients representing lighting and luminance variation between the reference templates T_{ref} and the training data, generating empirical samples tⁿ,lⁿ, n=1,2 . . . From these samples covariance representations representing typical variations are generated using sample correlation estimators

$${μ}_{L} = \frac{1}{N} {\sum }_{n = 1}^{N} {l}_{i}^{n} , {K}_{ik}^{L} = \frac{1}{N} {\sum }_{n = 1}^{N} {{l}_{i}^{n} ( {l}_{k}^{n} )}^{t} - {μ}_{L} .$$

denoting matrix transpose, and the covariance on colors

$${μ}_{C} = \frac{1}{N} {\sum }_{n = 1}^{N} {t}_{i}^{n} , {K}_{ik}^{C} = \frac{1}{N} {\sum }_{n = 1}^{N} {{t}_{i}^{n} ( {t}_{j}^{n} )}^{t} - {μ}_{C} , i , \\ j = R , G , B .$$

Having generated these functions we now have metrics that measure typical lighting variations and typical color tint variation. Such empirical covariances can be used for estimating the tint and color functions, adding the representations of the covariance metrics to the minimization procedures. The estimation of the lighting and color fields can be based on the training procedures via straightforward modification of the estimation of the lighting and color functions incorporating the covariance representations:

$${min}_{{l}_{1}^{R} , {l}_{1}^{G} , {l}_{1}^{B} …} {\sum }_{p ∈ {[ 0 , 1 ]}^{2}} {\sum }_{c = R , G , B} {( log \frac{{I}^{c} ( p )}{{T}_{ref}^{c} ( x ( p ) )} - {\sum }_{i = 1}^{d} {l}_{i}^{c} {ϕ}_{i} ( x ( p ) ) )}^{2} + {\sum }_{ik} {( {l}_{i} - {μ}_{L} )}^{t} {( {K}_{ik}^{L} )}^{- 1} ( {l}_{k} - {μ}_{k} ) . \qquad ( 13 )$$

For the color and lighting solution, the training data is added in a similar way to the estimation of the color model:

$${min}_{{t}_{R} , {t}_{G} , {t}_{B} , {l}_{1}^{R} , {l}_{1}^{G} , {l}_{1}^{B} …} {\sum }_{p ∈ {[ 0 , 1 ]}^{2}} {\sum }_{c = R , G , B} {( log \frac{{I}^{c} ( p )}{{T}_{ref}^{c} ( x ( p ) )} - {t}_{c} - {\sum }_{i = 1}^{d} {l}_{i} {ϕ}_{i} ( x ( p ) ) )}^{2} + {\sum }_{ik} {( {l}_{i} - {μ}_{L} )}^{t} {( {K}_{ik}^{L} )}^{- 1} ( {l}_{k} - {μ}_{L} ) + {\sum }_{ik} {( {t}_{i} - {μ}_{C} )}^{t} {( {K}_{ik}^{C} )}^{- 1} ( {t}_{k} - {μ}_{C} ) . \qquad ( 14 )$$

Texture Lifting to 3D Avatar Geometries

Texture Lifting from Multiple Views

In general, the colors that should be assigned to the polygonal faces of the selected avatar T_{ref}(x) are not known. The texture values may not be directly measured because of partial obscuration of the face caused, for example, by occlusion, glasses, camouflage, or hats.

If T_{ref} is unknown, but more than one image of the target, each taken from a different pose, are available I^{v}, v=1, 2, . . . , then T_{ref} can be estimated simultaneously with the unknown lighting fields L^{v} and the color representation for each instance under the multiplicative model T^{v}=L^{v}T_{ref}. When using such multiple views, the first step is to create a common coordinate system that accommodates the entire model geometry. The common coordinates are in 3D, based directly on the avatar vertices. To perform the photometric normalization and the texture field estimation a bijection p ∈ [0,1]²⇄x(p) ∈ R³ between the geometric avatar and the measured photographs must be obtained, as described in previous sections. For the multiple photographs there are multiple bijective correspondences p ∈ [0,1]²⇄x^{v}(p) ∈ R³, v=1, . . . , V between the CAD models and the planar images I^{v}, v=1, . . . The 3D avatar textures T^{v} are obtained from the observed images by lifting the observed imagery color values to the corresponding vertices on the 3D avatar via the predefined correspondences x^{v}(p) ∈ R³, v=1, . . . , V. The problem of estimating the lighting fields and reference texture field becomes the MMSE of each according to

$${min}_{{l}^{vR} , {l}^{vG} , {l}^{vB} , {T}_{ref}} {\sum }_{v = 1}^{V} {\sum }_{p ∈ {[ 0 , 1 ]}^{2}} {\sum }_{c = R , G , B} {( {I}^{vc} ( p ) - {ⅇ}^{{\sum }_{i = 1}^{D} {l}_{1}^{vc} {ϕ}_{l}^{v} ( x ( p ) )} {T}_{ref}^{c} ( x ( p ) ) )}^{2} . \qquad ( 15 )$$

with the summation over the V separate available views, each corresponding to a different target image. Standard minimization procedures can be used for estimating the unknowns, such as gradient descent and Newton-Raphson. The explicit parameterization via the color components for each RGB component can be added as above by indexing each RGB component with a different lighting field, or having a single color tint function. Standard minimization procedures can be used for estimating the unknowns. For the common lighting functions across the RGB components with different color tints it takes the form

$${min}_{{l}^{v} , {T}_{ref}} {\sum }_{v = 1}^{V} {\sum }_{p ∈ {[ 0 , 1 ]}^{2}} {\sum }_{c = R , G , B} {( {I}^{vc} ( p ) - {ⅇ}^{{\sum }_{i = 1}^{D} {l}_{1}^{v} {ϕ}_{l}^{v} ( x ( p ) )} {ⅇ}^{{t}_{c}} {T}_{ref}^{c} ( x ( p ) ) )}^{2} . \qquad ( 16 )$$

Texture Lifting in the Log Metric

Working in the log representation gives direct solutions for the optimizing reference texture field and the lighting functions simultaneously. Using log minimization the least-squares solution becomes

$${min}_{{l}^{v} , {T}_{ref}} {\sum }_{v = 1}^{V} {\sum }_{p ∈ {[ 0 , 1 ]}^{2}} {\sum }_{c = R , G , B} {( log \frac{{I}^{vc} ( p )}{{T}_{ref}^{c} ( x ( p ) )} - {\sum }_{i = 1}^{D} {l}_{i}^{vc} {ϕ}_{i}^{v} ( x ( p ) ) )}^{2} . \qquad ( 17 )$$

The summation over v corresponds to the V separate views available, each corresponding to a different target image. Performing the optimization with respect to the reference template texture gives the MMSE

$${T}_{ref}^{c} ( x ( p ) ) = {( {\prod }_{v = 1}^{V} {I}^{vc} ( p ) )}^{1 / V} {ⅇ}^{\frac{1}{V} {\sum }_{v = 1}^{V} {\sum }_{l = 1}^{L} {l}_{i}^{vc} {ϕ}_{i}^{v} ( x ( p ) )} , \\ c = R , G , B . \qquad ( 18 )$$

The MMSE problem for estimating the lighting becomes

$${min}_{{l}^{v}} {\sum }_{v = 1}^{V} {\sum }_{p ∈ {[ 0 , 1 ]}^{2}} {\sum }_{c = R , G , B} {( log \frac{{I}^{vc} ( p )}{{( {\prod }_{v = 1}^{V} {I}^{vc} ( p ) )}^{1 / V}} + {\sum }_{w = 1}^{V} {\sum }_{l = 1}^{L} {l}_{i}^{wc} {ϕ}_{l}^{w} ( p ) ( \frac{1}{v} - {δ}_{v}^{w} ) )}^{2} . \qquad ( 19 )$$

Defining

$${J}^{zc} ( p ) = {\sum }_{v = 1}^{V} log \frac{{I}^{vc} ( p )}{{( {\prod }_{v = 1}^{V} {I}^{vc} ( p ) )}^{1 / V}} ( {δ}_{v}^{z} - \frac{1}{V} ) ,$$

gives the LLSE equation given by
for

$$c = R , G , B , \\ j = 1 , … , d \\ {\sum }_{p = 1}^{P} {J}^{zc} ( p ) {ϕ}_{j}^{z} ( p ) = {\sum }_{v = 1}^{V} {\sum }_{i = 1}^{D} {\sum }_{p = 1}^{P} {l}_{i}^{vc} {ϕ}_{l}^{v} ( x ( p ) ) {ϕ}_{j}^{z} ( x ( p ) ) ( \frac{1}{v} - {δ}_{v}^{z} ) . \qquad ( 20 )$$

Texture Lifting, Single Symmetric View

If only one view is available, then the system uses reflective symmetry to provide a second view by using the symmetric geometric transformation estimates of O,b, and φ, as described above. For any feature point xᵢ on the CAD model, Oφ(xᵢ)+b≈zᵢPᵢ, and because of the symmetric geometric normalization constraint, ORφ(x_{σ(i)})+b≈zᵢPᵢ. To create a second view, I^{v}, the image is flipped about the y-axis: (x, y) [symbol] (−x, y). For the new view (−xᵢ/α₁, yᵢ/α₂,1)′=RPᵢ, so the rigid transformation for this view can be calculated since RORφ(x_{σ(i)})+Rb≈zᵢRPᵢ. Therefore the rigid motion estimate is given by (ROR, Rb) which defines the bijections p ∈ [0,1]²⇄x^{v}^{ₛ}(p) ∈ R³, v=1, . . . , V via the inverse mapping π:x [symbol] π(RORφ(x)+Rb). The optimization becomes:

$${min}_{{l}^{v} , {l}^{{v}_{s}} {T}_{ref}} {\sum }_{v = 1}^{V} {\sum }_{p ∈ {[ 0 , 1 ]}^{2}} {\sum }_{c = R , G , B} {( {I}^{vc} ( p ) - {ⅇ}^{{\sum }_{i = 1}^{D} {l}_{i}^{vc} {ϕ}_{l}^{v} ( {x}^{v} ( p ) )} {T}_{ref}^{c} ( {x}^{v} ( p ) ) )}^{2} + {( {I}^{{v}_{s} c} ( p ) - {ⅇ}^{{\sum }_{i = 1}^{D} {l}_{i}^{{v}_{s} c} {ϕ}_{l}^{{v}_{s}} ( {x}^{{v}_{s}} ( p ) )} {T}_{ref}^{c} ( {x}^{{v}_{s}} ( p ) ) )}^{2} . \qquad ( 21 )$$

Geometric Lifting from 2D Imagery and 3D Imagery

2D to 3D Geometric Lifting with Correspondence Features

In many situations, the system is required to determine the geometric and photometric normalization simultaneously. Full geometric normalization requires lifting the 2D projective feature points and dense imagery information into the 3D coordinates of the avatar shape to determine the pose, shape and the facial expression. Begin by assuming that only the sparse feature points are used for the geometric lifting, and that they are defined in correspondence between points on the avatar 3D geometry and the 2D projective imagery, concentrating on extracted features associated with points, curves, or subareas in the image plane. Given the starting imagery I(p), p ∈ [0,1]², the set of xⱼ=(xⱼ, yⱼ, zⱼ), j=1, . . . , N features is defined on the candidate avatar and to a correspondence to a similar set of features in the projective imagery pⱼ=(pⱼ₁, pⱼ₂) ∈ [0,1]², j=1, . . . , N. The projective geometry mapping is defined as either positive or negative z projecting along the z axis with rigid transformation of the form O, b:x [symbol] Ox+b around object center

$$x = ( \begin{matrix}x \\ y \\ z\end{matrix} ) ↦ Ox + b ,$$

where

$$O = ( \begin{matrix}{0}_{11} & {o}_{12} & {o}_{13} \\ {o}_{21} & {o}_{22} & {o}_{23} \\ {o}_{31} & {o}_{32} & {o}_{33}\end{matrix} ) , \\ b = ( \begin{matrix}{b}_{x} \\ {b}_{y} \\ {b}_{z}\end{matrix} ) .$$

The search for the best-fitting avatar pose (corresponding to the optimal rotation and translation for the selected avatar) uses the invariant features as follows. Given the projective points in the image plane pⱼ, j=1, 2, . . . , N and a rigid transformation of the form O, b:x⇄Ox+b, with

$${p}_{i} = ( \frac{{α}_{1} {x}_{i}}{{z}_{i}} , \frac{{α}_{2} {y}_{i}}{{z}_{i}} ) , \\ i = 1 , … , N , \\ {P}_{i} = ( \frac{{p}_{i 1}}{{α}_{1}} , \frac{{p}_{i 2}}{{α}_{2}} , 1 ) , \\ {Q}_{i} = ( id - \frac{{{P}_{i} ( {P}_{i} )}^{′}}{{‖ {P}_{i} ‖}^{2}} ) ,$$

where id is the 3×3 identity matrix. As described in U.S. patent application Ser. No. 10/794,353, the cost function (a measure of the aggregate distance between the projected invariant points of the avatar and the corresponding points in the measured target image) is evaluated by exhaustively calculating the lifted zᵢ, i=1, . . . , N. Using MMSE estimation, choosing the minimum cost function, gives the lifted z-depths corresponding to:

$${min}_{z , O , b} {\sum }_{i = 1}^{N} {‖ {Ox}_{i} + b - {z}_{i} P ‖}_{{R}^{3}}^{2} = {min}_{O , b} {\sum }_{i = 1}^{N} {( {Ox}_{i} + b )}^{t} {Q}_{i} ( {Ox}_{i } + b ) . \qquad ( 22 )$$

Choosing a best-fitting predefined avatar involves the database of avatars, with CAD−α,α=1, 2, . . . the number of total avatar models each with labeled features xⱼ^{α}, j=1, . . . , N. Selecting the optimum CAD model minimizes overall cost function, choosing the optimally fit CAD model.

$$CAD = {min}_{{CAD}^{α} , O , b} {\sum }_{i = 1}^{N} {( {Ox}_{i}^{α} + b )}^{t} {Q}_{i} ( {Ox}_{i}^{α} + b ) . \qquad ( 23 )$$

In a typical situation, there will be prior information about the position of the object in three-space. For example, in a tracking system the position from the previous track will be available, implying a constraint on the translation can be added to the minimization. The invention may incorporate this information into the matching process, assuming prior point information μ ∈ R³, and a rigid transformation of the form x [symbol] Ox+b, the MMSE of rotation and translation satisfies

$${min}_{z , O , b} {\sum }_{i = 1}^{N} {‖ {Ox}_{i} + b - {z}_{i} {P}_{i} ‖}_{{ℝ}^{3}}^{2} + {( b - μ )}^{t} {Σ}^{- 1} ( b - μ ) = {min}_{O , b} {\sum }_{i = 1}^{N} {( {Ox}_{i} + b )}^{t} {Q}_{i} ( {Ox}_{i} + b ) + {( b - μ )}^{t} {Σ}^{- 1} ( b - μ ) . \qquad ( 24 )$$

Once the best fitting avatar has been selected, the avatar geometry is shaped by combining with the rigid motions geometric shape deformation. To combine the rigid motions with the large deformations the transformation x [symbol] φ(x), x ∈ CAD is defined relative to the avatar CAD model coordinates. The large deformation may include shape change, as well as expression optimization. The large deformations of the CAD model with φ: x [symbol] φ(x) generated according to the flow

$$ϕ = {ϕ}_{1} , {ϕ}_{t} = {\int }_{0}^{t} {v}_{s} ( {ϕ}_{s} ( x ) ) ⅆ s + x , x ∈ CAD$$

are described in U.S. patent application Ser. No. 10/794,353. The deformation of the CAD model corresponding to the mapping x [symbol] φ(x), x ∈ CAD is generated by performing the following minimization:

$${min}_{{v}_{t} , t ∈ [ 0 , 1 ] , {z}_{n}} {\int }_{0}^{1} {‖ {v}_{t} ‖}_{V}^{2} ⅆ t + {\sum }_{i = 1}^{N} {‖ ϕ ( {x}_{i} ) - {z}_{i} {P}_{i} ‖}_{{ℝ}^{3}}^{2} = {min}_{{v}_{t} , t ∈ [ 0 , 1 ]} {\int }_{0}^{1} {‖ {v}_{t} ‖}_{V}^{2} ⅆ t + {\sum }_{i = 1}^{N} {ϕ ( {x}_{i} )}^{t} {Q}_{i} ϕ ( {x}_{i} ) , \qquad ( 25 )$$

where ∥vₜ∥ᵥ² is the Sobelev norm with v satisfying smoothness constraints associated with ∥vₜ∥ᵥ². The norm can be associated with a differential operator L representing the smoothness enforced on the vector fields, such as the Laplacian and other forms of derivatives so that ∥vₜ∥ᵥ²=∥Lvₜ∥²; alternatively smoothness is enforced by forcing the Sobelev space to be a reproducing kernel Hilbert space with a smoothing kernel. All of these are acceptable methods. Adding the rigid motions gives a similar minimization problem

$${min}_{O , b , {v}_{t} , t ∈ [ 0 , 1 ] , {z}_{n}} {\int }_{0}^{1} {‖ {v}_{t} ‖}_{V}^{2} ⅆ t + {\sum }_{i = 1}^{N} {‖ O ϕ ( {x}_{i} ) + b - {z}_{i} {P}_{i} ‖}_{{ℝ}^{3}}^{2} = {min}_{O , b , {v}_{t} , t ∈ [ 0 , 1 ]} {\int }_{0}^{1} {‖ {v}_{t} ‖}_{V}^{2} ⅆ t + {\sum }_{i = 1}^{2 N} {( O ϕ ( {x}_{i} ) + b )}^{t} {Q}_{i} ( O ϕ ( {x}_{i} ) + b ) . \qquad ( 26 )$$

Such large deformations can represent expressions, jaw motion as well as large deformation shape change, following U.S. patent application Ser. No. 10/794,353. In another embodiment, the avatar may be deformed with small deformations only representing the large deformation according to the linear approximation x→x+u(x), x ∈ CAD:

$${min}_{O , b , u , {z}_{n}} {‖ u ‖}_{V}^{2} + {\sum }_{n = 1}^{N} {‖ O ( {x}_{n} + u ( {x}_{n} ) ) + b - {z}_{n} {P}_{n} ‖}_{{ℝ}^{3}}^{2} = {min}_{O , b , u} {‖ u ‖}_{V}^{2} + {\sum }_{n = 1}^{N} {( O ( {x}_{n} + u ( {x}_{n} ) ) + b )}^{t} {Q}_{n} ( O ( {x}_{n} + u ( {x}_{n} ) ) + b ) . \qquad ( 27 )$$

Expressions and jaw motions can be added directly by writing the vector fields u in a basis representing the expressions as described in U.S. patent application Ser. No. 10/794,353. In order to track such changes, the motions may be parametrically defined via an expression basis E₁, E₂, . . . so that

$$u ( x ) = {\sum }_{i} {e}_{i} {E}_{i} ( x ) .$$

These are defined as functions that describe how a smile, eyebrow lift and other expressions cause the invariant features to move on the face. The coefficients e₁,e₂, . . . describing the magnitude of each expression, become the unknowns to be estimated. For example, jaw motion corresponds to a flow of points in the jaw following a rotation around the fixed jaw axis O(γ): x [symbol] O(γ)x where O rotates the jaw points around the jaw axis γ.

2D to 3D Geometric Lifting Using Symmetry

For symmetric objects such as the face, the system uses a reflective symmetry constraint in both rigid motion and deformation estimation to gain extra power. Again the CAD model coordinates are centered at the origin such that its plane of symmetry is aligned with the yz-plane. Therefore, the reflection matrix is simply

$$R = ( \begin{matrix}- 1 & 0 & 0 \\ 0 & 1 & 0 \\ 0 & 0 & 1\end{matrix} )$$

and R: x [symbol] Rx is the reflection of x about the plane of symmetry on the CAD model. Given the features xᵢ=(xᵢ, yᵢ, zᵢ), i=1, . . . , N. the system defines σ: {1, . . . , N} [symbol] {1, . . . , N} to be the permutation such that xᵢ and x_{σ(i)} are symmetric pairs for all i=1, . . . , N. In order to enforce symmetry the system adds an identical set of constraints on the reflection of the original set of model points. In the case of rigid motion estimation, the symmetry requires that an observed feature in the projective plane matches both the corresponding point on the model (under the rigid motion) (O, b): x [symbol] Oxᵢ+b, as well as the reflection of the symmetric pair on the model, ORx_{σ(i)}+b. Similarly, the deformation, φ, applied to a point xᵢ should be the same as that produced by the reflection of the deformation of the symmetric pair Rφ(x_{σ(i)}). This amounts to augmenting the optimization to include two constraints for each feature point instead of one. The rigid motion estimation reduces to the same structure as in U.S. patent application Ser. Nos. 10/794,353 and 10/794,943 with 2N instead of N constraints and takes a similar form as the two view problem, as described therein.

The rigid motion minimization problem with the symmetric constraint becomes, defining \tilde{x}=(x₁, . . ., x_{N}, Rx_{σ(1)}, . . . , Rx_{σ(N)}) and \tilde{Q}=(Q₁, . . . , Q_{N}, Q₁, . . . , Q_{N}), then

$${min}_{O , b} {\sum }_{i = 1}^{N} {‖ {Ox}_{i} + b - {z}_{i} {P}_{i} ‖}_{{ℝ}^{3}}^{2} + {‖ {ORx}_{σ ( i )} + b - {z}_{σ ( i )} {P}_{σ ( i )} ‖}_{{ℝ}^{3}}^{2} = {min}_{O , b} {\sum }_{i = 1}^{N} ( {( {Ox}_{i} + b )}^{t} {Q}_{i} ( {Ox}_{i} + b ) + {( {ORx}_{σ ( i )} + b )}^{t} {Q}_{i} ( {ORx}_{σ ( i )} + b ) ) = {min}_{O , b} {\sum }_{i = 1}^{2 N} {( O {\tilde{x}}_{i} + b )}^{t} {\tilde{Q}}_{i} ( O {\tilde{x}}_{i} + b ) , \qquad ( 28 )$$

which is in the same form as the original rigid motion minimization problem, and is solved in the same way. Selecting the optimum CAD model minimizes the overall cost function, choosing the optimally fit CAD model.

$$CAD = {arg min }_{{CAD}^{α}} {min}_{O , b} {\sum }_{i = 1}^{2 N} {( O {\tilde{x}}_{i}^{α} + b )}^{t} {\tilde{Q}}_{i} ( O {\tilde{x}}_{i}^{α} + b ) . \qquad ( 29 )$$

For symmetric deformation estimation, the minimization problem becomes

$${min}_{O , b , {v}_{t} , t ∈ [ 0 , 1 ]} {\int }_{0}^{1} {‖ {v}_{t} ‖}_{V}^{2} ⅆ t + {\sum }_{i = 1}^{2 N} {( O ϕ ( {x}_{i} ) + b )}^{t} {Q}_{i} ( O ϕ ( {x}_{i} ) + b ) + {\sum }_{i = 1}^{N} {( OR ϕ ( {x}_{i} ) + b )}^{t} {Q}_{σ ( i )} ( OR ϕ ( {x}_{i} ) + b ) , \qquad ( 30 )$$

which is in the form of the multiview deformation estimation problem (for two views) as discussed in U.S. patent application Ser. Nos. 10/794,353 and 10/794,943, and is solved in the same way.

2D to 3D Geometric Lifting Using Unlabeled Feature Points in the Projective Plane

For many applications feature points are available on the avatar and in the projective plane but there is no labeled correspondence between them. For example, defining contour features such the lip line, boundaries, and eyebrow curves via segmentation methods or dynamic programming delivers a continuum of unlabeled points. In addition, intersections of well defined sub areas (boundary of the eyes, nose, etc., in the image plane) along with curves of points on the avatar generate unlabeled features. Given the set of xⱼ ∈ R³, j=1, . . . , N features defined on the candidate avatar along with direct measurements in the projective image plane, with

$${p}_{i} = ( \frac{{α}_{1} {x}_{i}}{{z}_{i}} , \frac{{α}_{2} {y}_{i}}{{z}_{i}} ) , \\ i = 1 , … , M , \\ {P}_{i} = ( \frac{{p}_{i 1}}{{α}_{1}} , \frac{{p}_{i 2}}{{α}_{2}} , 1 ) ,$$

with γᵢ=M/N, β=1, then the rigid motion of the CAD model is estimated according to

$${min}_{O , b , {z}_{n}} {\sum }_{ij} K ( {Ox}_{i} + b , {Ox}_{j} + b ) {γ}_{i} {γ}_{j} - 2 {\sum }_{ij} K ( {Ox}_{i} + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} . \qquad ( 31 )$$

Performing the avatar CAD model selection takes the form

$$CAD = {argmin}_{{CAD}^{α}} {min}_{O , b , {z}_{n}} {\sum }_{ij} K ( {Ox}_{i}^{α} + b , {Ox}_{i}^{α} + b ) {γ}_{i} {γ}_{j} - 2 {\sum }_{ij} K ( {Ox}_{i}^{α} + b , {z}_{j} {P}_{j} ) {γ}_{i} {β}_{j} + {\sum }_{ij} K ( {z}_{i} , {P}_{i} , {z}_{j} {P}_{j} ) {β}_{i} {β}_{j} . \qquad ( 32 )$$

Adding symmetry to the unlabeled matching is straightforward. Let xⱼ^{s-a} ∈ R³, j=1, . . . , P be a symmetric set of avatar feature points to xⱼ with γᵢ=M/N, βᵢ=1, then estimating the ID with the symmetric constraint becomes

$$CAD = {arg min}_{{CAD}^{α}} {min}_{O , b , {z}_{n}} {\sum }_{ij}^{} K ( {Ox}_{i}^{α} + b , {Ox}_{j}^{α} + b ) {γ}_{i} {γ}_{j} - 2 {\sum }_{ij}^{} K ( {Ox}_{i}^{α} + b , {z}_{j} {P}_{j} ) {γ}_{i} {β}_{j} + {\sum }_{ij}^{} K ( {z}_{i} {P}_{i} , {z}_{j} {P}_{j} ) {β}_{i} {β}_{j} + {\sum }_{ij}^{} K ( {ORx}_{i}^{s - α} + b , {( {ORx}_{j}^{s - α} )}_{} + b ) {γ}_{i} {γ}_{j} - 2 {\sum }_{ij}^{} K ( {ORx}_{i}^{s - α} + b , {z}_{j} {P}_{j} ) {γ}_{i} {β}_{j} + {\sum }_{ij}^{} K ( {z}_{i} {P}_{i} , {z}_{j} {P}_{j} ) {β}_{i} {β}_{j} . \qquad ( 33 )$$

Adding shape deformations gives

$$CAD = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{ij}^{} K ( O ϕ ( {x}_{i}^{α} ) + b , O ϕ ( {x}_{j}^{α} ) + b ) {γ}_{i} {γ}_{j} - 2 {\sum }_{ij}^{} K ( O ϕ ( {x}_{i}^{α} ) + b , {z}_{j} {P}_{j} ) {γ}_{i} {β}_{j} + {\sum }_{ij}^{} {K}_{} ( {z}_{i} {P}_{i} , {z}_{j} {P}_{j} ) {β}_{i} {β}_{j} + {\sum }_{ij}^{} K ( OR ϕ ( {x}_{i}^{s - α} ) + b , OR {ϕ ( {x}_{j}^{s - α} )}_{} + b ) {γ}_{i} {γ}_{j} - 2 {\sum }_{ij}^{} K ( OR ϕ ( {x}_{i}^{s - α} ) + b , {z}_{j} {P}_{j} ) {γ}_{i} {β}_{j} + {\sum }_{ij}^{} K ( {z}_{i} {P}_{i} , {z}_{j} {P}_{j} ) {β}_{i} {β}_{j} . \qquad ( 34 )$$

Removing symmetry involves removing the last three terms.

3D to 3D Geometric Lifting via 3D Labeled Features

The above discussion describes how 2D information about a 3D target can be used to produce the avatar geometries from projective imagery. Direct 3D target information is sometimes available, for example from a 3D scanner, structured light systems, camera arrays, and depth-finding systems. In addition, dynamic programming on principal curves on the avatar 3D geometry, such as ridge lines, points of maximal or minimum curvature, produces unlabeled correspondences between points in the 3D avatar geometry and those manifest in the 2D image plane. For such cases the geometric correspondence is determined by unmatched labeling. Using such information can enable the system to construct triangulated meshes, detect 0, 1, 2, or 3-dimensional features, i.e., points, curves, subsurfaces and subvolumes. Given the set of xⱼ ∈ R³, j=1, . . . , N features defined on the candidate avatar along with direct 3D measurements yⱼ ∈ R³, j=1, . . . , N in correspondence with the avatar points, then the rigid motion of the CAD model is estimated according to

$${min}_{O , b} {\sum }_{i = 1}^{N} {( {Ox}_{i} + b - {y}_{i} )}^{t} {K}^{- 1} ( {Ox}_{i} + b - {y}_{i} ) , \qquad ( 35 )$$

where K is the 3N by 3N covariance matrix representing measurement errors in the features xⱼ, yⱼ ∈ R³, j=1, . . . , N. Symmetry is straightforwardly added as above in 3D

$${min}_{O , b} {\sum }_{i = 1}^{N} {( {Ox}_{i} + b - {y}_{i} )}^{t} {K}^{- 1} ( {Ox}_{i} + b - {y}_{i} ) + {\sum }_{i = 1}^{N} {( {ORx}_{σ ( i )} + b - {y}_{i} )}^{t} {K}^{- 1} ( {ORx}_{σ ( i )}^{α} + b - {y}_{i} ) . \qquad ( 36 )$$

Adding prior information on position gives

$${min}_{O , b} {\sum }_{i = 1}^{N} {( {Ox}_{i} + b - {y}_{i} )}^{t} {K}^{- 1} ( {Ox}_{i} + b - {y}_{i} ) + {\sum }_{i = 1}^{N} {( {ORx}_{σ ( i )} + b - {y}_{i} )}^{t} {K}^{- 1} ( {ORx}_{σ ( i )} + b - {y}_{i} ) + {( b - μ )}^{t} {Σ}^{- 1} ( b - μ ) . \qquad ( 37 )$$

The optimal CAD model is selected according to

$$CAD = {arg min}_{{CAD}^{α}} {min}_{O , b} {\sum }_{i = 1}^{N} {( {Ox}_{i}^{α} + b - {y}_{i} )}^{t} {K}^{- 1} ( {Ox}_{i}^{α} + b - {y}_{i} ) + {\sum }_{i = 1}^{N} {( {ORx}_{σ ( i )}^{α} + b - {y}_{i} )}^{t} {K}^{- 1} ( {ORx}_{σ ( i )}^{α} + b - {y}_{i} ) . \qquad ( 38 )$$

Removing symmetry for geometry lifting or model selection involves removing the second symmetric term in the equations.

3D to 3D Geometric Lifting via 3D Unlabeled Features

The 3D data structures can provide curves, subsurfaces, and subvolumes consisting of unlabeled points in 3D. Such feature points are detected hierarchically on the 3D geometries from points of high curvature, principal and gyral curves associated with extrema of curvature, and subsurfaces associated particular surface properties as measured by the surface normals and shape operators. Using unmatched labeling, let there be xⱼ ∈ R³, j=1, . . . , N avatar feature points, and yⱼ ∈ R³, j=1, . . . , M with γᵢ=M/N, βᵢ=1, the rigid motion of the avatar is estimated from the MMSE of

$${min}_{O , b} {\sum }_{ij}^{} K ( {Ox}_{i} + b , {Ox}_{j} + b ) {γ}_{i} {γ}_{j} - 2 {\sum }_{ij}^{} K ( {Ox}_{i} + b , {y}_{j} ) {γ}_{i} {β}_{j} + {\sum }_{ij}^{} K ( {y}_{i} , {y}_{j} ) {β}_{i} {β}_{j} + {( b - μ )}^{t} {Σ}^{- 1} ( b - μ ) . \qquad ( 39 )$$

Performing the avatar CAD model selection takes the form

$$CAD = {arg min}_{{CAD}^{α}} {min}_{O , b} {\sum }_{ij}^{} {\sum }_{ij}^{} K ( {Ox}_{i}^{α} + b , {Ox}_{j}^{α} + b ) {γ}_{i} {γ}_{j} - 2 {\sum }_{ij}^{} K ( {Ox}_{i}^{α} + b , {y}_{j} ) {γ}_{i} {β}_{j} + {\sum }_{ij}^{} K ( {y}_{i} , {y}_{j} ) {β}_{i} {β}_{j} . \qquad ( 40 )$$

Adding symmetry, let xⱼ^{s-a} ∈ R³, j=1, . . . , P be a symmetric set of avatar feature points to xⱼ with γᵢ=M/N, then lifting the geometry with symmetry gives

$${min}_{O , b} {\sum }_{ij}^{} K ( {Ox}_{i} + b , {Ox}_{j} + b ) {γ}_{i} {γ}_{j} - 2 {\sum }_{ij}^{} K ( {Ox}_{i} + b , {y}_{j} ) {γ}_{i} {β}_{j} + {\sum }_{ij}^{} K ( {y}_{i} , {y}_{j} ) {β}_{i} {β}_{j} + {\sum }_{ij}^{} K ( {ORx}_{i}^{s} + b , {{ORx}_{j}^{s}}_{} + b ) {γ}_{i} {γ}_{j} - 2 {\sum }_{ij}^{} K ( {ORx}_{i}^{s} + b , {y}_{j} ) {γ}_{i} {β}_{j} + {\sum }_{ij}^{} K ( {y}_{i} , {y}_{j} ) {β}_{i} {β}_{j} . \qquad ( 41 )$$

Lifting the model selection with the symmetric constraint becomes

$$CAD = {arg min}_{{CAD}^{α}} {min}_{O , b} {\sum }_{ij}^{} K ( {Ox}_{i}^{α} + b , {Ox}_{j}^{α} + b ) {γ}_{i} {γ}_{j} - 2 {\sum }_{ij}^{} K ( {Ox}_{i}^{α} + b , {y}_{j} ) {γ}_{i} {β}_{j} + {\sum }_{ij}^{} K ( {y}_{i} , {y}_{j} ) {β}_{i} {β}_{j} + {\sum }_{ij}^{} K ( {ORx}_{i}^{s - α} + b , {{ORx}_{j}^{s - α}}_{} + b ) {γ}_{i} {γ}_{j} - 2 {\sum }_{ij}^{} K ( {ORx}_{i}^{s - α} + b , {y}_{j} ) {γ}_{i} {β}_{j} + {\sum }_{ij}^{} K ( {y}_{i} , {y}_{j} ) {β}_{i} {β}_{j} . \qquad ( 42 )$$

Adding the shape deformations with symmetry gives minimization for the unmatched labeling of the form

$${min}_{O , b , {v}_{t} , t ∈ [ 0 , 1 ]} {\int }_{0}^{1} {‖ {v}_{t} ‖}_{V}^{2} ⅆ t + {\sum }_{ij} K ( O ϕ ( {x}_{i} ) + b , O ϕ ( {x}_{j} ) + b ) {γ}_{i} {γ}_{j} - 2 {\sum }_{ij} K ( O ϕ ( {x}_{i} ) + b , {y}_{j} ) {γ}_{i} {β}_{j} + {\sum }_{ij} K ( {y}_{i} , {y}_{j} ) {β}_{i} {β}_{j} + {\sum }_{ij} K ( O R ϕ ( {x}_{i}^{s} ) + b , O R ϕ ( {x}_{j}^{s} ) + b ) {γ}_{i} {γ}_{j} - 2 {\sum }_{ij} K ( O R ϕ ( {x}_{i}^{s} ) + b , {y}_{j} ) {γ}_{i} {β}_{j} + {\sum }_{ij} K ( {y}_{i} , {y}_{j} ) {β}_{i} {β}_{j} . \qquad ( 43 )$$

Selecting the CAD model with symmetry and shape deformation takes the form

$$CAD = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{ij} K ( O ϕ ( {x}_{i}^{α} ) + b , O ϕ ( {x}_{j}^{α} ) + b ) {γ}_{i} {γ}_{j} - 2 {\sum }_{ij} K ( O ϕ ( {x}_{i}^{α} ) + b , {y}_{j} ) {γ}_{i} {β}_{j} + {\sum }_{ij} K ( {y}_{i} , {y}_{j} ) {β}_{i} {β}_{j} + {\sum }_{ij} K ( O R ϕ ( {x}_{i}^{s - α} ) + b , O R ϕ ( {x}_{j}^{s - α} ) + b ) {γ}_{i} {γ}_{j} - 2 {\sum }_{ij} K ( O R ϕ ( {x}_{i}^{s - α} ) + b , {y}_{j} ) {γ}_{i} {β}_{j} + {\sum }_{ij} K ( {y}_{i} , {y}_{j} ) {β}_{i} {β}_{j} . \qquad ( 44 )$$

To perform shape lifting and CAD model selection without symmetry, the last 3 symmetric terms are removed.

3D to 3D Geometric Lifting via Unlabeled Surface Normal Metrics

Direct 3D target information is often available, for example from a 3D scanner, providing direct information about the surface structures and their normals. Using information from 3D scanners can enable the lifting of geometric features directly to the construction of triangulated meshes and other surface data structures. For such cases the geometric correspondence is determined via unmatched labeling that exploits metric properties of the normals of the surface. Let xⱼ ∈ R³, j=1, . . . , N index the CAD model avatar facets, let yⱼ ∈ R³, j=1, . . . , M be the target data, define N(f) ∈ R³ to be the normal of face f weighted by its area, let c(f) be the center of its face, and let N(g) ∈ R³ be the normal of the target data with face g. Define K to be the 3×3 matrix valued kernel indexed over the surface. Estimating the rigid motion of the avatar is the MMSE corresponding to the unlabeled matching minimization

$${min}_{O , b} {\sum }_{ij = 1}^{N} {N ( {f}_{j} )}^{t} K ( O c ( {f}_{i} ) + b , O c ( {f}_{j} ) + b ) N ( {f}_{i} ) - 2 {\sum }_{ij} {N ( {f}_{j} )}^{t} K ( O c ( {g}_{i} ) + b , c ( {f}_{j} ) N ( {g}_{i} ) {\sum }_{ij = 1}^{N} {N ( {g}_{j} )}^{t} K ( O c ( {g}_{i} ) + b , O c ( {g}_{j} ) + b ) N ( {g}_{i} ) . \qquad ( 45 )$$

Selecting the optimum CAD models becomes

$${arg min}_{{CAD}^{α}} {min}_{O , b ,} {\sum }_{ij = 1}^{N} {N ( {f}_{j}^{α} )}^{t} K ( O c ( {f}_{i}^{α} ) + b , O c ( {f}_{j}^{α} ) + b ) N ( {f}_{i}^{α} ) - 2 {\sum }_{ij} {N ( {f}_{j}^{α} )}^{t} K ( O c ( {g}_{i} ) + b , c ( {f}_{j}^{α} ) N ( {g}_{i} ) + {\sum }_{ij = 1}^{N} {N ( {g}_{j} )}^{t} K ( O c ( {g}_{i} ) + b , O c ( {g}_{j} ) + b ) N ( {g}_{i} ) . \qquad ( 46 )$$

Adding shape deformation to the generation of the 3D avatar coordinate systems gives

$${min}_{O , b , {v}_{t} , t ∈ [ 0 , 1 ]} {\int }_{0}^{1} {‖ {v}_{t} ‖}_{V}^{2} ⅆ t + {\sum }_{ij = 1}^{N} {N ( {f}_{j} )}^{t} K ( ϕ ( c ( {f}_{i} ) ) , ϕ ( c ( {f}_{j} ) ) ) N ( {f}_{i} ) - 2 {\sum }_{ij} {N ( {f}_{j} )}^{t} K ( ϕ ( c ( {g}_{i} ) ) , c ( {f}_{j} ) N ( {g}_{i} ) + {\sum }_{ij = 1}^{N} {N ( {g}_{j} )}^{t} K ( ϕ ( c ( {g}_{i} ) ) , ϕ ( c ( {g}_{j} ) ) ) N ( {g}_{i} ) \qquad ( 47 )$$

2D to 3D Geometric Lifting Via Dense Imagery (Without Correspondence)

In another embodiment, as described in U.S. patent application Ser. No. 10/794,353, the geometric transformations are constructed directly from the dense set of continuous pixels representing the object, in which case observed N feature points may not be delineated in the projective imagery or in the avatar template models. In such cases, the geometrically normalized avatar can be generated from the dense imagery directly. Assume the 3D avatar is at orientation and translation (O,b) under the Euclidean transformation x [symbol] Ox+b, with associated texture field T(O,b). Define the avatar at orientation and position (O,b) the template T(O,b). Then model the given image I(p), p ∈ [0,1]² as a noisy representation of the projection of the avatar template at the unknown position (O,b). The problem is to estimate the rotation and translation O, b which minimizes the expression

$${min}_{O , b} {\sum }_{p ∈ {[ 0 , 1 ]}^{2}} {‖ I ( p ) - T ( O , b ) ( x ( p ) ) ‖}_{{ℝ}^{3}}^{2} \qquad ( 48 )$$

where x(p) indexes through the 3D avatar template. In the situation where targets are tracked in a series of images, and in some instances when a single image only is available, knowledge of the position of the center of the target will often be available. This knowledge is incorporated as described above, by adding the prior information via the position information

$${min}_{O , b} {\sum }_{p ∈ {[ 0 , 1 ]}^{2}} {‖ I ( p ) - T ( O , b ) ( x ( p ) ) ‖}_{{ℝ}^{3}}^{2} + {( b - μ )}^{t} {\sum }^{- 1} ( b - μ ) . \qquad ( 49 )$$

This minimization procedure is accomplished via diffusion matching as described in U.S. patent application Ser. No. 10/794,353. Further including annotated features give rise to jump diffusion dynamics. Shape changes and expressions corresponding to large deformations with φ: x [symbol] O(x) satisfying

$$ϕ = {ϕ}_{1 ,} {ϕ}_{t} = {\int }_{0}^{t} {v}_{s} ( {ϕ}_{s} ( x ) ) ⅆ s + x , x ∈ CAD$$

are generated:

$${min}_{O , b , {v}_{t} , t ∈ [ 0 , 1 ]} {\int }_{0}^{1} {‖ {v}_{t} ‖}_{V}^{2} ⅆ t + {\sum }_{p ∈ {[ 0 , 1 ]}^{2}} {‖ I ( p ) - T ( O , b ) ( ϕ ( x ( p ) ) ) ‖}_{{ℝ}^{3}}^{2} . \qquad ( 50 )$$

As above in the small deformation equation, for small deformation φ:x [symbol] (x)≈x+u(x). To represent expressions directly, the transformation can be written in the basis E₁, E₂, . . . as above with the coefficients e₁, e₂, . . . describing the magnitude of each expression's contribution to the variables to be estimated.

The optimal rotation and translation may be computed using the techniques described above, by first performing the optimization for the rigid motion alone, and then performing the optimization for shape transformation. Alternatively, the optimum expressions and rigid motions may be computed simultaneously by searching over their corresponding parameter spaces simultaneously.

For dense matching, the symmetry constraint is applied in a similar fashion by applying the permutation to each element of the avatar according to

$${min}_{O , b , {v}_{t} , t ∈ [ 0 , 1 ]} {\int }_{0}^{1} {‖ {v}_{t} ‖}_{V}^{2} ⅆ t + {\sum }_{p ∈ {[ 0 , 1 ]}^{2}} {‖ I ( p ) - T ( O , b ) ( ϕ ( x ( p ) ) ) ‖}_{{ℝ}^{3}}^{2} + {\sum }_{p ∈ {[ 0 , 1 ]}^{2}} {‖ I ( p ) - T ( O , b ) ( R ϕ ( σ ( x ( p ) ) ) ) ‖}_{{ℝ}^{{3}_{.}}}^{2} \qquad ( 51 )$$

Photometric, Texture and Geometry Lifting

When the geometry and photometry and texture are unknown, then the lifting must be performed simultaneously. In this case, the images I^{v}, v=1, 2, . . . , are available and the unknowns are the CAD models with their associated bijections p ∈ [0,1]²⇄x^{v}(p) ∈ R³, v=1, . . . , V defined by rigid motions O^{v},b^{v},v=1,2, . . . , along with T_{ref} being unknown and the unknown lighting fields L^{v} determining the color representations for each instance under the multiplicative model T^{v}=L^{v}T_{ref}. When using such multiple views, the first step is to create a common coordinate system that accommodates the entire model geometry. The common coordinates are in 3D, based directly on the avatar vertices. To perform the photometric normalization and the texture field estimation for the multiple photographs there are multiple bijective correspondences p ∈ [0,1]²⇄x^{v}(p) ∈ R³, v=1, . . . , V between the CAD models and the planar images I^{v}, v=1, . . . The first step is to estimate the CAD models geometry either from labeled points in 2D or 3D or via unlabeled points or via dense matching. This follows the above sections for choosing and shaping the geometry of the CAD model to be consistent with the geometric information in the observed imagery, and determining the bijections between the observed imagery and the fixed CAD model. For one instance, if given the projective points in the image plane pⱼ, j=1, 2, . . . , N with

$${p}_{i} = ( \frac{{α}_{1} {x}_{i}}{{z}_{i}} , \frac{{α}_{2} {y}_{i}}{{z}_{i}} ) , i = 1 , … , N , \\ {P}_{i} = ( \frac{{p}_{i 1}}{{α}_{1}} , \frac{{p}_{i 2}}{{α}_{2}} , 1 ) , \\ {Q}_{i} = ( id - \frac{{{P}_{i} ( {P}_{i} )}^{t}}{{‖ {P}_{i} ‖}^{2}} ) ,$$

where id is the 3×3 identity matrix, and the cost function (a measure of the aggregate distance between the projected invariant points of the avatar and the corresponding points in the measured target image) using MMSE estimation, then a best-fitting predefined avatar can be chosen from the database of avatars, with CAD^{α}, α=1, 2, . . . , each with labeled features xⱼ^{α}, j=1, . . . , N. Selecting the optimum CAD model minimizes the overall cost function:

$$CAD = {min}_{{CAD}^{α} , O , b} {\sum }_{i = 1}^{N} {( O {x}_{i}^{α} + b )}^{t} {Q}_{i} ( O {x}_{i}^{α} + b ) .$$

Alternatively, the CAD model geometry could be selected by symmetry, unlabeled points, or dense imagery, or any of the above methods for geometric lifting. Given the CAD model, the 3D avatar reference texture and lighting fields T^{v}=L^{v}T_{ref} are obtained from the observed images by lifting the observed imagery color values to the corresponding vertices on the 3D avatar via the correspondences x^{v}(p) ∈ R³, v=1, . . . , V defined by the geometric information. The problem of estimating the lighting fields and reference texture field becomes the MMSE of each according to

$${min}_{{l}^{vR} , {l}^{vG} , {l}^{vB} , {T}_{ref}} {\sum }_{v = 1}^{V} {\sum }_{p ∈ {[ 0 , 1 ]}^{2}} {\sum }_{c = R , G , B} {( {I}^{vc} ( p ) - {ⅇ}^{{\sum }_{i = 1}^{D} {l}_{i}^{vc} {ϕ}_{l}^{v} ( x ( p ) )} {T}_{ref}^{c} ( {x}^{v} ( p ) ) )}^{2} \qquad ( 52 )$$

with the summation over the V separate available views, each corresponding to a different target image. Alternatively, the color tinting model or the log-normalization equations as defined above are used.

Normalization of Photometry and Geometry

Photometric Normalization of 3D Avatar Texture

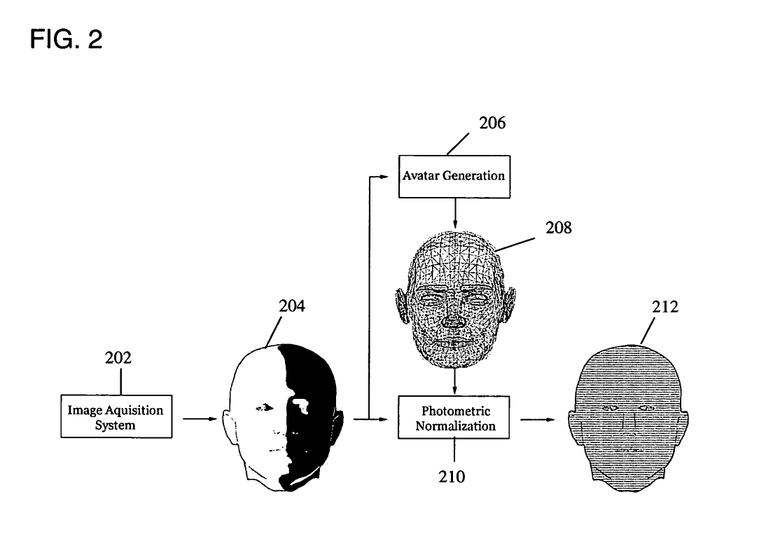

The basic steps of photometric normalization are illustrated in FIG. 2. Image acquisition system 202 captures a 2D image 204 of the target head. As described above, the system generates (206) best fitting avatar 208 by searching through a library of reference avatars, and by deforming the reference avatars to accommodate permanent or intrinsic features as well as temporary or non-intrinsic features of the target head. Best-fitting generated avatar 208 is photometrically normalized (210) by applying “normal” lighting, which usually corresponds to uniform, white lighting.

For the fixed avatar geometry CAD model, the lighting normalization process exploits the basic model that the texture field of the avatar CAD model has the multiplicative relationship T(x(p))=L(x(p))T_{ref}(x(p)). For generating the photometrically normalized avatar CAD model with texture imagery T(x), x ∈ CAD, the inverse of the MMSE lighting field L in the multiplicative group is applied to the texture field:
L⁻¹:T(x) [symbol] T^{norm}(x)=L⁻¹(x)·T(x),x ∈ CAD. (53)
For the vector version of the lighting field this corresponds to componentwise division of each component of the lighting field (with color) into each component of the vector texture field.

Photometric Normalization of 2D Imagery

Referring again to FIG. 2, best-fitting avatar 208 illuminated with normal lighting is projected into 2D to generate photometrically normalized 2D imagery 212.

For the fixed avatar geometry CAD model, generating normalized 2D projective imagery, the lighting normalization process exploits the basic model that the image I is in bijective correspondence with the avatar with the multiplicative relationship I(p)⇄T(x(p))=L(x(p))T_{ref}(x(p)); for multiple images I^{v}(p)⇄T^{v}(x(p))=L^{v}(x(p))T_{ref}(x(p)). Thus normalized imagery can be generated by dividing out the lighting field. For the lighting model in which each component has a lighting function according to

$$T ( x ) = ( \begin{matrix}\underbrace{{ⅇ}^{ {\sum }_{i = 1}^{ d} {l}_{i}^{R} {ϕ}_{ i} ( x )}}_{{L}^{R}} {T}_{ref}^{R} ( x ) , \\ \underbrace{{ⅇ}^{ {\sum }_{i = 1}^{ d} {l}_{i}^{G} {ϕ}_{ i} ( x )}}_{{L}^{G}} {T}_{ref}^{G} ( x ) , \underbrace{{ⅇ}^{ {\sum }_{i = 1}^{ d} {l}_{i}^{B} {ϕ}_{ i} ( x )}}_{{L}^{B}} {T}_{ref}^{B} ( x )\end{matrix} ) \qquad ( 54 )$$

then the normalized imagery is generated according to the direct relationship

$${I}_{norm} ( p ) = ( \frac{{I}^{R} ( p )}{{L}^{R} ( x ( p ) )} , \frac{{I}^{G} ( p )}{{L}^{G} ( x ( p ) )} , \frac{{I}^{B} ( p )}{{L}^{B} ( x ( p ) )} ) . \qquad ( 55 )$$

In a second embodiment in which there is the common lighting field with separate color components

$$T ( x ) = ( \begin{matrix}{ⅇ}^{{t}_{R} + {\sum }_{i = 1}^{ d} {l}_{i}^{} {ϕ}_{ i} ( x )} {T}_{ref}^{R} ( x ) , \\ {ⅇ}^{{t}_{G} + {\sum }_{i = 1}^{ d} {l}_{i}^{} {ϕ}_{ i} ( x )} {T}_{ref}^{G} ( x ) , {ⅇ}^{{t}_{B} + {\sum }_{i = 1}^{ d} {l}_{i}^{} {ϕ}_{ i} ( x )} {T}_{ref}^{B} ( x )\end{matrix} ) \qquad ( 56 )$$

then the normalization takes the form

$${I}_{norm} ( p ) = \frac{1}{L ( x ( p ) )} ( {ⅇ}^{- {t}_{R}} {I}^{R} ( p ) , {ⅇ}^{- {t}_{G}} {I}^{G} ( p ) , {ⅇ}^{- {t}_{B}} {I}^{B} ( p ) ) . \qquad ( 57 )$$

In a third embodiment, we view the change as small and additive, which implies that the general model becomes T(x)=ε(x)+T_{ref}(x). The normalization then takes the form
Iₙₒᵣₘ(p)=(I^{R}(p),I^{G}(p),I^{B}(p))−(ε^{R}(x(p)),ε^{G}(x(p)),ε^{B}(x(p))). (58)
In such an embodiment the small deformation may have a single common shared basis

Nonlinear Spatial Filtering of Lighting Variations and Symmetrization

In general, the variations in the lighting across the face of a subject are gradual, resulting in large-scale variations. By contrast, the features of the target face cause small-scale, rapid changes in image brightness. In another embodiment, the nonlinear filtering and symmetrization of the smoothly varying part of the texture field is applied. For this, the symmetry plane of the models is used for calculating the symmetric pairs of points in the texture fields. These values are averaged, thereby creating a single texture field. This average may only be preferentially applied to the smoothly varying components of the texture field (which exhibit lighting artifacts).

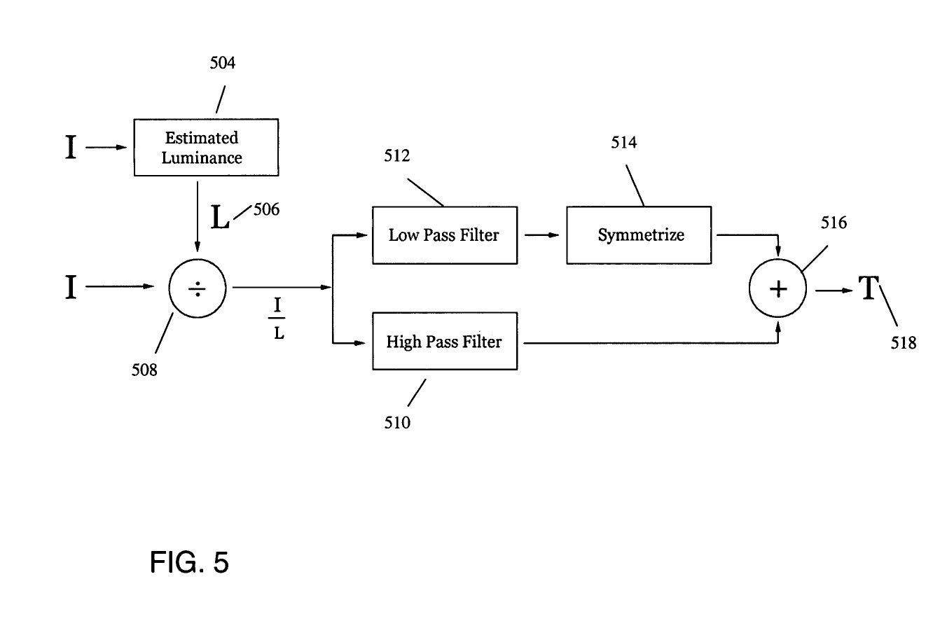

FIG. 5 illustrates a method of removing lighting variations. Local luminance values L (506) are estimated (504) from the captured source image I (502). Each measured value of the image is divided (508) by the local luminance, providing a quantity that is less dependent on lighting variations and more dependent on the features of the source object. Small spatial scale variations, deemed to stem from source features, are selected by high pass filter 510 and are left unchanged. Large spatial scale variations, deemed to represent lighting variations, are selected by low pass filter 512, and are symmetrized (514) to remove lighting artifacts. The symmetrized smoothly varying component and the rapidly varying component are added together (516) to produce an estimate of the target texture field 518.

For the small variations in lighting, the local lighting field estimates can be subtracted from the captured source image values, rather than being divided into them.

Geometrically Normalized 3D Geometry

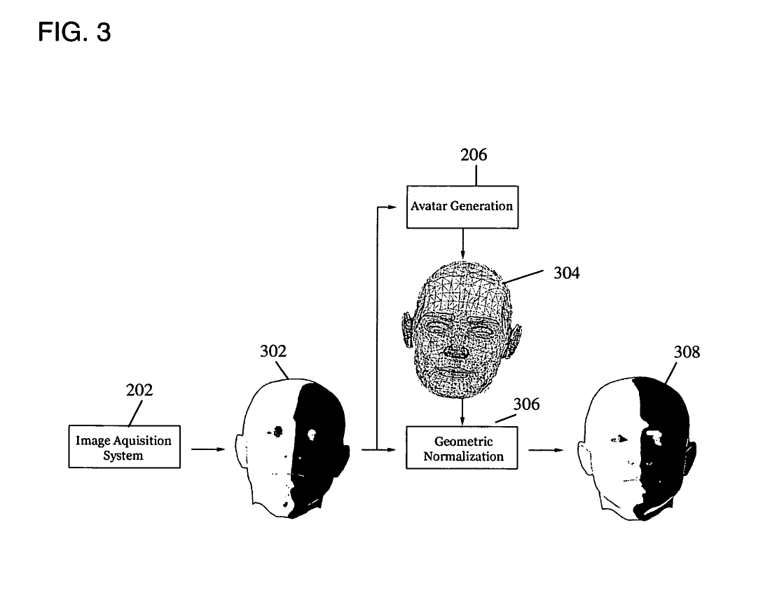

The basic steps of geometric normalization are illustrated in FIG. 3. Image acquisition system 202 captures 2D image 302 of the target head. As described above, the system generates (206) best fitting avatar 304 by searching through a library of reference avatars, and by deforming the reference avatars to accommodate permanent or intrinsic features as well as temporary or non-intrinsic features of the target head. Best-fitting avatar is geometrically normalized (306) by backing out deformations corresponding to non-intrinsic and non-permanent features of the target head. Geometrically normalized 2D imagery 308 is generated by projecting the geometrically normalized avatar into an image plane corresponding to a normal pose, such as a face-on view.

Given the fixed and known avatar geometry, as well as the texture field T(x) generated by lifting sparse corresponding feature points, unlabeled feature points, surface normals, or dense imagery, the system constructs normalized versions of the geometry by applying the inverse transformation.

From the rigid motion estimation O,b, the inverse transformation is applied to every point on the 3D avatar (O, b)⁻¹: x ∈ CAD [symbol] O^{t}(x−b), as well as to every normal by rotating the normals O,b: N(x) [symbol] O′N(x). This new collection of vertex points and normals forms the new geometrically normalized avatar model
CAD^{norm}={(y,N(y)):y=O^{t}(x−b),N(y)=O^{t}N(x),x ∈ CAD (59)
The rigid motion also carries all the texture field T(x), x ∈ CAD of the original 3D avatar model according to
T^{norm}(x)=T(Ox+b),x ∈ CAD^{norm}. (60)
The rigid motion normalized avatar is now in neutral position, and can be used for 3D matching as well as to generate imagery in normalized pose position.
From the shape change φ, the inverse transformation is applied to every point on the 3D avatar φ⁻¹: x ∈ CAD [symbol] φ⁻¹(x) as well as to every normal by rotating the normals by the Jacobian of the mapping at every point φ⁻¹: N(x)c ∈ (Dφ)⁻¹(x)N(x) where Dφ is the Jacobian of the mapping. The shape change also carries all of the surface normals as well as the associated texture field of the avatar
T^{norm}(x)=T(φ(x)),x ∈ CAD^{norm}. (61)
The shape normalized avatar is now in neutral position, and can be used for 3D matching as well to generate imagery in normalized pose position.
For the small deformation deformations φ(x)≈x+u(x), the approximate inverse transformation is applied to every point on the 3D avatar φ⁻¹: x ∈ CAD [symbol] x−u(x). As well the normals are transformed via the Jacobian of the linearized part of the mapping Du, and the texture is transformed as above T^{norm}(x)=T(x+u(x)), x ∈ CAD^{norm}.

The photometrically normalized imagery is now generated from the geometrically normalized avatar CAD model with transformed normals and texture field as described in the photometric normalization section above. For normalizing the texture field photometrically, the inverse of the MMSE lighting field L in the multiplicative group is applied to the texture field. Combining with the geometric normalization gives
T^{norm}(x)=L⁻¹(·)T(·)(Ox+b),x ∈ CAD^{norm}. (62)
Adding the shape change gives the photometrically normalized texture field
T^{norm}(x)=L⁻¹(·)T(·)(φ(x)),x ∈ CAD^{norm}. (63)

Geometry Unknown, Photometric Normalization

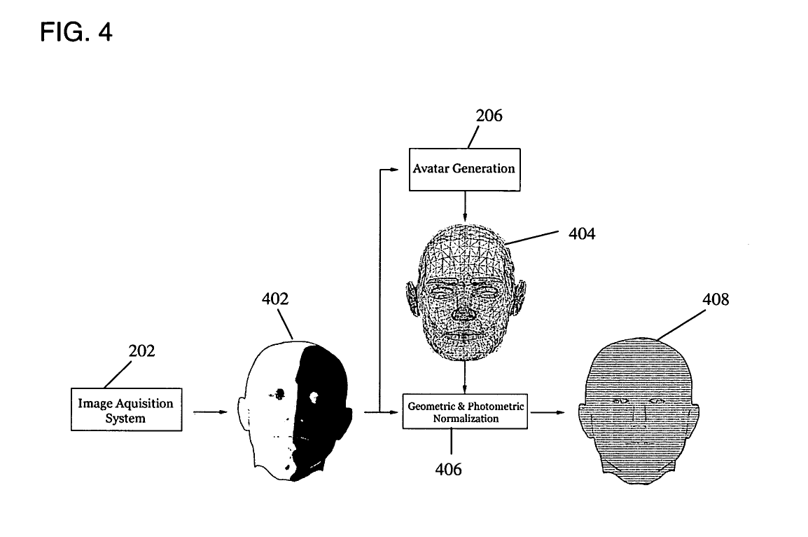

In many settings the geometric normalization must be performed simultaneously with the photometric normalization. This is illustrated in FIG. 4. Image acquisition system 202 captures target image 402 and generates (206) best-fitting avatar 404 using the methods described above. Best-fitting avatar is geometrically normalized by backing out deformations corresponding to non-intrinsic and non-permanent features of the target head (406). The geometrically normalized avatar is lit with normal lighting (406), and projected into an image plane corresponding to a normal pose, such as a face-on view. The resulting image 408 is geometrically normalized with respect to shape (expressions and temporary surface alterations) and pose, as well as photometrically normalized with respect to lighting.

In this situation, the first step is to run the feature-based procedure for generating the selected avatar CAD model that optimally represents the measured photographic imagery. This is accomplished by defining the set of (i) labeled features, (ii) the unlabeled features, (iii) 3D labeled features, (iv) 3D unlabeled features, or (v) 3D surface normals. The avatar CAD model geometry is then constructed from any combination of these, using rigid motions, symmetry, expressions, and small or large deformation geometry transformation.

If given multiple sets of 2D or 3D measurements, the 3D avatar geometry can be constructed from the multiple sets of features.

The rigid motion also carries all the texture field T(x), x ∈ CAD of the original 3D avatar model according to T^{norm}(x)=T(Ox+b), x ∈ CAD^{norm}, or alternatively T^{norm}(x)=T(φ(x)), x ∈ CAD^{norm}, where the normalized CAD model is
CAD^{norm}={(y,N(y)):y=O^{t}(x−b),N(y)=O^{t}N(x),x ∈ CAD}. (64)
The texture field of the avatar can be normalized by the lighting field as above according to
T^{norm}(x)=L⁻¹(·)T(·)(Ox+b)),x ∈ CAD^{norm}. (65)
Adding the shape change gives the photometrically normalized texture field
T^{norm}(x)=L⁻¹(·)T(·)(φ(x)),x ∈ CAD^{norm}. (66)
The small variation representation can be used as well.

Once the geometry is known from the associated photographs, the 3D avatar geometry has the correspondence p ∈ [0,1^{]}²⇄x(p) ∈ R³ defined between it and the photometric information via the bijection defined by the rigid motions and shape transformation. For generating the normalized imagery in the projective plane from the original imagery, the imagery can be directly normalized in the image plane according to

$${I}_{norm} ( p ) = ( \frac{{I}^{R} ( p )}{{L}^{R} ( x ( p ) )} , \frac{{I}^{G} ( p )}{{L}^{G} ( x ( p ) )} , \frac{{I}^{B} ( p )}{{L}^{B} ( x ( p ) )} ) . \qquad ( 67 )$$

Similarly, the direct color model can be used as well

$${I}_{norm} ( p ) = \frac{1}{L ( x ( p ) )} ( {ⅇ}^{- {t}_{R}} {I}^{R} ( p ) , {ⅇ}^{- {t}_{G}} {I}^{G} ( p ) , {ⅇ}^{- {t}_{B}} {I}^{B} ( p ) ) . \qquad ( 68 )$$

ID Lifting

Identification systems attempt to identify a newly captured image with one of the images in a database of images of ID candidates, called the registered imagery. Typically the newly captured image, also called the probe, is captured with a pose and under lighting conditions that do not correspond to the standard pose and lighting conditions that characterize the images in the image database.

ID Lifting Using Labeled Feature Points in the Projective Plane

Given registered imagery and probes, ID or matching can be performed by lifting the photometry and geometry into the 3D avatar coordinates as depicted in FIG. 4. Given bijections between the registered image I_{reg} and the 3D avatar model geometry, and between the probe image I_{probe} and its 3D avatar model geometry, the 3D coordinate systems can be exploited directly. For such a system, the registered imagery are first converted to 3D CAD models, call them CAD^{α}, α=1, . . . , A, with textured model correspondences I_{reg}(p)⇄T_{reg}(x(p)),x ∈ CAD−reg. These CAD models can be generated using any combination of 2D labeled projective points, unlabeled projective points, labeled 3D points, unlabeled 3D points, unlabeled surface normals, as well as dense imagery in the projective plane. In the case of dense imagery measurements, the texture fields T_{CAD}_{^{α}} generated using the bijections described in the previous sections are associated with the CAD models.

Performing ID amounts to lifting the measurements of the probes to the 3D avatar CAD models and computing the distance metrics between the probe measurements and the registered database of CAD models. Let us enumerate each of the metric distances. Given labeled features points pᵢ=(pᵢ₁,pᵢ₂),i=1, . . . , N for each probe I_{probe}(p), P ∈ [0,1]² in the image plane, and on each of the CAD models the labeled feature points xᵢ^{α} ∈ CAD^{α},i=1, . . . , N, α=1, . . . , A, then the ID corresponds to choosing the CAD models which minimize the distance to the probe:

$$ID = {arg min}_{{CAD}^{α}} {min}_{O , b} {\sum }_{i = 1}^{N} {( {( O {x}_{i}^{α} + b )}^{t} {Q}_{i} ( O {x}_{i}^{α} + b ) + ( O R {x}_{i}^{α} ) + b )}^{t} {Q}_{σ ( i )} ( O R {x}_{i}^{α} + b ) ) . \qquad ( 69 )$$

Adding the deformations to the metric is straightforward as well according to

$$ID = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{i = 1}^{N} {( O ϕ ( {x}_{i}^{α} ) + b )}^{t} {Q}_{i} ( O ϕ ( {x}_{i}^{α} ) + b ) + {\sum }_{i = 1}^{N} {( O R ϕ ( {x}_{i}^{α} ) + b )}^{t} {Q}_{σ ( i )} ( O R ϕ ( {x}_{i}^{α} ) + b ) . \qquad ( 70 )$$

Removing symmetry amounts to removing the second term. Adding expressions and small deformation shape change is performed as described above.

ID Lifting Using Unlabeled Feature Points in the Projective Plane

If given probes with unlabeled features points in the image plane, the metric distance can also be computed for ID. Given the set of xⱼ ∈ R³, j=1, . . . , N features defined on the CAD models along with direct measurements in the projective image plane, with

$${p}_{i} = ( \frac{{α}_{1} {x}_{i}}{{z}_{i}} , \frac{{α}_{2} {y}_{i}}{{z}_{i}} ) , i = 1 , … , M , \\ {P}_{i} = ( \frac{{p}_{i 1}}{{α}_{1}} , \frac{{p}_{i 2}}{{α}_{2}} , 1 ) , with {γ}_{i} = M / N , {β}_{i} = 1 ,$$

then the ID corresponds to choosing the CAD models which minimize the distance to the probe

$$ID = {arg min}_{{CAD}^{α}} {min}_{O , b , {z}_{n}} {\sum }_{ij} K ( O {x}_{i}^{α} + b , O {x}_{j}^{α} + b ) {γ}_{i} {γ}_{j} - 2 {\sum }_{ij} K ( O {x}_{i}^{α} + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} . \qquad ( 71 )$$

Let xⱼ^{s-a} ∈ R³, j=1, . . . , P be a symmetric set of avatar feature points to xⱼ with γᵢ=M/N, then estimating the ID with the symmetric constraint becomes

$$ID = {arg min}_{{CAD}^{α}} {min}_{O , b , {z}_{n}} {\sum }_{ij} K ( O {x}_{i}^{α} + b , O {x}_{j}^{α} + b ) {γ}_{i} {γ}_{j} - 2 {\sum }_{ij} K ( O {x}_{i}^{α} + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} + {\sum }_{ij} K ( O R {x}_{i}^{s - α} + b , O R {x}_{j}^{s - α} + b ) {γ}_{i} {γ}_{j} - 2 {\sum }_{ij} K ( O R {x}_{i}^{2 - α} + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} . \qquad ( 72 )$$

Adding shape deformations gives

$$ID = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{ij} K ( O ϕ ( {x}_{i}^{α} ) + b , O ϕ ( {x}_{j}^{α} ) + b ) {γ}_{i} {γ}_{j} - 2 {\sum }_{ij} K ( O ϕ ( {x}_{i}^{α} ) + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} + {\sum }_{ij} K ( O R ϕ ( {x}_{i}^{s - α} ) + b , O R ϕ ( {x}_{j}^{s - α} ) + b ) {γ}_{i} {γ}_{j} - 2 {\sum }_{ij} K ( O R ϕ ( {x}_{i}^{s - α} ) + b , {z}_{j} {P}_{j} ) {γ}_{i} {β}_{j} + {\sum }_{ij} K ( {z}_{i} {P}_{i} , {z}_{j} {P}_{j} ) {β}_{i} {β}_{j} . \qquad ( 73 )$$

ID Lifting Using Dense Imagery

When the probe is given in the form of dense imagery with labeled or unlabeled feature points, then the dense matching with symmetry corresponds to determining ID by minimizing the metric

$$ID = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{p ∈ {[ 0 , 1 ]}^{2}} {‖ I ( p ) - {T}_{{CAD}^{α}} ( O , b ) ( ϕ ( x ( p ) ) ) ‖}_{{ℝ}^{3}}^{2} + {\sum }_{p ∈ {[ 0 , 1 ]}^{2}} {‖ I ( p ) - {T}_{{CAD}^{α}} ( O , b ) ( ϕ ( R σ ( x ( p ) ) ) ) ‖}_{{ℝ}^{3}}^{2} . \qquad ( 74 )$$

Removing symmetry involves removing the last symmetric term.

ID Lifting Via 3D Labeled Points

Target measurements performed in 3D may be available if a 3D scanner or other 3D measurement device is used. If 3D data is provided, direct 3D identification from 3D labeled feature points is possible. Given the set of xⱼ ∈ R³, j=1, . . . , N features defined on the candidate avatar along with direct 3D measurements yⱼ ∈ R³, j=1, . . . , N in correspondence with the avatar points, then the ID of the CAD model is selected according to

$$ID = {arg min}_{{CAD}^{α}} {min}_{O , b} {\sum }_{i = 1}^{N} {( O {x}_{i}^{α} + b - {y}_{i} )}^{t} {K}^{- 1} ( O {x}_{i}^{α} + b - {y}_{i} ) + {( O R {x}_{σ ( i )}^{α} + b - {y}_{i} )}^{t} {K}^{- 1} ( O R {x}_{σ ( i )}^{α} + b - {y}_{i} ) . \qquad ( 75 )$$

where K is the 3N by 3N covariance matrix representing measurement errors in the features xⱼ, yⱼ ∈ R³, j=1, . . . , N. Removing symmetry to the model selection criterion involves removing the second term.

ID Lifting via 3D Unlabeled Features

The 3D data structures can have curves and subsurfaces and subvolumes consisting of unlabeled points in 3D. For use in ID via unmatched labeling let there be xⱼ^{α} ∈ R³, j=1, . . . , N avatar feature points, and yⱼ ∈ R³, j=1, . . . , M with γᵢ=M/N, βᵢ=1. Estimating the D then takes the form

$$ID = {arg min}_{{CAD}^{α}} {min}_{O , b} {\sum }_{ij} K ( O {x}_{i}^{α} + b , O {x}_{j}^{α} + b ) {γ}_{i} {γ}_{j} - 2 {\sum }_{ij} K ( O {x}_{i}^{α} + b , {y}_{j} ) {γ}_{i} {β}_{j} + {\sum }_{ij} K ( {y}_{i} , {y}_{j} ) {β}_{i} {β}_{j} . \qquad ( 76 )$$

Let xⱼ^{s} ∈ R³, j=1, . . . , P be a symmetric set of avatar feature points to xⱼ with γᵢ=M/N, then estimating the ID with the symmetric constraint becomes

$$ID = {arg min}_{{CAD}^{α}} {min}_{O , b} {\sum }_{ij} K ( O {x}_{i}^{α} + b , O {x}_{j}^{α} + b ) {γ}_{i} {γ}_{j} - 2 {\sum }_{ij} K ( O {x}_{i}^{α} + b , {y}_{j} ) {γ}_{i} {β}_{j} + {\sum }_{ij} K ( {y}_{i} , {y}_{j} ) {β}_{i} {β}_{j} + {\sum }_{ij} K ( O R {x}_{i}^{s - α} + b , O R {x}_{j}^{s - α} + b ) {γ}_{i} {γ}_{j} - 2 {\sum }_{ij} K ( O R {x}_{i}^{s - α} + b , {y}_{j} ) {γ}_{i} {β}_{j} + {\sum }_{ij} K ( {y}_{i} , {y}_{j} ) {β}_{i} {β}_{j} . \qquad ( 77 )$$

Adding the shape deformations gives minimization for the unmatched labeling

$$ID = {arg min}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{ij} K ( O ϕ ( {x}_{i}^{α} ) + b , O ϕ ( {x}_{j}^{α} ) + b ) {γ}_{i} {γ}_{j} - 2 {\sum }_{ij} K ( O ϕ ( {x}_{i}^{α} ) + b , {y}_{j} ) {γ}_{i} {β}_{j} + {\sum }_{ij} K ( {y}_{i} , {y}_{j} ) {β}_{i} {β}_{j} + {\sum }_{ij} K ( O R ϕ ( {x}_{i}^{s - α} ) + b , O R ϕ ( {x}_{j}^{s - α} ) + b ) {γ}_{i} {γ}_{j} - 2 {\sum }_{ij} K ( O R ϕ {x}_{i}^{s - α} + b , {y}_{j} ) {γ}_{i} {β}_{j} + {\sum }_{ij} K ( {y}_{i} , {y}_{j} ) {β}_{i} {β}_{j} . \qquad ( 78 )$$

Removing symmetry involves removing the last 3 terms in the equation.

ID Lifting Via 3D Measurement Surface Normals

Direct 3D target information, for example from a 3D scanner, can provide direct information about the surface structures and their normals. Using information from 3D scanners provides the geometric correspondence based on both labeled and unlabeled formulation. The geometry is determined via unmatched labeling, exploiting metric properties of the normals of the surface. Let fⱼ ∈ R³, j=1, . . . , N index the CAD model avatar facets, let gⱼ ∈ R³, j=1, . . . , M the target data, define N(f) ∈ R³ to the normal of face f weighted by its area on the CAD model, let c(f) be the center of its face, and let N(g) ∈ R³ be the normal of the target data with face g . Define K to be the 3×3 matrix valued kernel indexed over the surface. Given unlabeled matching, the minimization with symmetry takes the form

$$\begin{matrix}ID = {arg min}_{{CAD}^{α}} {min}_{O , b} {\sum }_{ij = 1} {N ( {Of}_{j}^{α} + b )}^{t} K ( Oc ( {f}_{i}^{α} ) + b , Oc ( {f}_{j}^{α} ) + b ) N ( {Of}_{i}^{α} + b ) ) - 2 {\sum }_{ij} {N ( {Of}_{j}^{α} + b )}^{t} K ( c ( {g}_{i} ) , Oc ( {f}_{j}^{α} ) + b ) N ( {g}_{i} ) + {\sum }_{ij = 1} {N ( {g}_{j} )}^{t} K ( c ( {g}_{i} ) , c ( {g}_{j} ) ) N ( {g}_{i} ) + {\sum }_{ij = 1} {N ( {ORh}_{j}^{α} + b )}^{t} K ( ORc ( {h}_{i}^{α} ) + b , ORc ( {h}_{j}^{α} ) + b ) N ( {ORh}_{i}^{α} + b ) - 2 {\sum }_{ij} {N ( {ORh}_{j}^{α} + b )}^{t} K ( c ( {g}_{i} ) , ORc ( {h}_{j}^{α} ) + b ) N ( {g}_{i} ) + {\sum }_{ij = 1} {N ( {g}_{j} )}^{t} K ( c ( {g}_{i} ) , c ( {g}_{j} ) ) N ( {g}_{i} ) . & ( 79 ) \\ ID = {arg min}_{{CAD}^{α}} {min}_{O , b} {\sum }_{ij = 1} {N ( {Of}_{j}^{α} + b )}^{t} K ( Oc ( {f}_{i}^{α} ) + b , Oc ( {f}_{j}^{α} ) + b ) N ( {Of}_{i}^{α} + b ) ) - 2 {\sum }_{ij} {N ( {Of}_{j}^{α} + b )}^{t} K ( c ( {g}_{i} ) , Oc ( {f}_{j}^{α} ) + b ) N ( {g}_{i} ) + {\sum }_{ij = 1} {N ( {g}_{j} )}^{t} K ( c ( {g}_{i} ) , c ( {g}_{j} ) ) N ( {g}_{i} ) + {\sum }_{ij = 1} {N ( {ORh}_{j}^{α} + b )}^{t} K ( ORc ( {h}_{i}^{α} ) + b , ORc ( {h}_{j}^{α} ) + b ) N ( {ORh}_{i}^{α} + b ) - 2 {\sum }_{ij} {N ( {ORh}_{j}^{α} + b )}^{t} K ( c ( {g}_{i} ) , ORc ( {h}_{j}^{α} ) + b ) N ( {g}_{i} ) + {\sum }_{ij = 1} {N ( {g}_{j} )}^{t} K ( c ( {g}_{i} ) , c ( {g}_{j} ) ) N ( {g}_{i} ) . & ( 80 )\end{matrix}$$

Adding shape deformation to the generation of the 3D avatar coordinate systems

$$ID = {argmin}_{{CAD}^{α}} {min}_{O , b , {v}_{t} , t ∈ [ 0 , 1 ]} {\int }_{0}^{1} {‖ {v}_{t} ‖}_{V}^{2} ⅆ t + {\sum }_{ij = 1}^{N} {N ( ϕ ( {f}_{j}^{α} ) )}^{t} K ( ϕ ( c ( {f}_{i}^{α} ) ) , ϕ ( c ( {f}_{j}^{α} ) ) ) N ( ϕ ( {f}_{i}^{α} ) ) - 2 {\sum }_{ij} {N ( ϕ ( {f}_{j}^{α} ) )}^{t} K ( c ( {g}_{i} ) , ϕ ( c ( {f}_{j}^{α} ) ) ) N ( {g}_{i} ) + {\sum }_{ij = 1}^{N} {N ( {g}_{j} )}^{t} K ( c ( {g}_{i} ) , c ( {g}_{j} ) ) N ( {g}_{i} ) + {\sum }_{ij = 1}^{n} {N ( R ϕ ( {f}_{j}^{α} ) )}^{t} K ( R ϕ ( c ( {f}_{i}^{α} ) ) , R ϕ ( c ( {f}_{j}^{α} ) ) ) N ( R ϕ ( {f}_{i}^{α} ) ) - 2 {\sum }_{ij} {N ( R ϕ ( {f}_{j}^{α} ) )}^{t} K ( c ( {g}_{i} ) , R ϕ ( c ( {f}_{j}^{α} ) ) ) N ( {g}_{i} ) + {\sum }_{ij = 1}^{N} {N ( {g}_{j} )}^{t} K ( c ( {g}_{i} ) , c ( {g}_{j} ) ) N ( {g}_{i} ) . \qquad ( 81 )$$

Removing symmetry involves removing the last 3 terms in the equations.

ID Lifting Using Textured Features

Given registered imagery and probes, ID can be performed by lifting the photometry and geometry into the 3D avatar coordinates. Assume that bijections between the registered imagery and the 3D avatar model geometry, and between the probe imagery and its 3D avatar model geometry are known. For such a system, the registered imagery is first converted to 3D CAD models CAD^{α}, α=1, . . . , A with textured model correspondences I_{CAD}_{^{α}}(p)⇄T_{CAD}_{^{α}}(x(p)),x ∈ CAD^{α}. The 3D CAD models and correspondences between the textured imagery can be generated using any of the above geometric features in the image plane including 2D labeled projective points, unlabeled projective points, labeled 3D points, unlabeled 3D points, unlabeled surface normals, as well as dense imagery in the projective plane. In the case of dense imagery measurements, associated with the CAD models are the texture fields T_{CAD}_{^{α}} generated using the bijections described in the previous sections. Performing ID via the texture fields amounts to lifting the measurements of the probes to the 3D avatar CAD models and computing the distance metrics between the probe measurements and the registered database of CAD models. One or more probe images I_{probe}^{v}(p),p ∈ [0,1]², v=1, . . . , V in the image plane are given. Also given are the geometries for each of the CAD models CAD^{α}, α=1, . . . , A, together with associated texture fields T_{CAD}_{^{α}}, α=1, . . . , A. Determining the ID from the given images corresponds to choosing the CAD models with texture fields that minimize the distance to the probe:

$$ID = {arg min}_{{CAD}^{α}} {min}_{{l}^{vR} , {l}^{vG} , {l}^{vB}} {\sum }_{v = 1}^{V} {\sum }_{p ∈ {[ 0 , 1 ]}^{2}} {\sum }_{c = R , G , B} {( {I}_{probe}^{vc} ( p ) - \\ {ⅇ}^{{\sum }_{i = 1}^{D} {l}_{i}^{vc} {ϕ}_{i}^{v} ( x ( p ) )} {T}_{{CAD}^{α}}^{c} ( x ( p ) ) )}^{2} . \qquad ( 82 )$$

with the summation over the V separate available views, each corresponding to a different version of the probe image. Performing ID using the single channel model with multiplicative color model takes the form

$$ID = {arg min}_{{CAD}^{α}} {min}_{{l}^{vR} , {l}^{vG} , {l}^{vB}} {\sum }_{v = 1}^{V} {\sum }_{p ∈ {[ 0 , 1 ]}^{2}} {\sum }_{c = R , G , B} {( {I}_{probe}^{vc} ( p ) - {ⅇ}^{{\sum }_{i = 1}^{D} {l}_{i}^{v} {ϕ}_{i}^{v} ( x ( p ) )} {ⅇ}^{{t}_{c}} {T}_{{CAD}^{α}}^{c} ( x ( p ) ) )}^{2} . \qquad ( 83 )$$

A fast version of the ID may be accomplished using the log-minimization:

$$ID = {arg min}_{{CAD}^{α}} {min}_{{l}^{v}} {\sum }_{v = 1}^{V} {\sum }_{p ∈ {[ 0 , 1 ]}^{2}} {\sum }_{c = R , G , B} {( log \frac{{I}_{probe}^{vc} ( p )}{{T}_{{CAD}^{α}}^{c} ( x ( p ) )} - {\sum }_{i = 1}^{D} {l}_{i}^{vc} {ϕ}_{i}^{v} ( x ( p ) ) )}^{2} . \qquad ( 84 )$$

ID Lifting Using Geometric and Textured Features

ID can be performed by matching both the geometry and the texture features. Here both the texture and the geometric information is lifted simultaneously and compared to the avatar geometries. Assume we are given the dense probe images I_{probe}(p), p ∈ [0,1]² in the image plane, along with labeled features in each of the probes

$${p}_{j} , j = 1 , 2 , … , N$$

$$with$$

$${p}_{i} = ( \frac{{α}_{1} {x}_{i}}{{z}_{i}} , \frac{{α}_{2} {y}_{i}}{{z}_{i}} ) , \\ i = 1 , … , N , \\ {P}_{i} = ( \frac{{p}_{i 1}}{{α}_{1}} , \frac{{p}_{i 2}}{{α}_{2}} , 1 ) , \\ {Q}_{i} = ( id - \frac{{{P}_{i} ( {P}_{i} )}^{t }}{{‖ {P}_{i} ‖}^{2}} ) ,$$

where id is the 3×3 identity matrix. Let the CAD model geometries be CAD^{α}, α=1, . . . , A, their texture fields be T_{CAD}_{^{α}}, α=1, . . . , A, and assume each of the CAD models has labeled feature points xᵢ^{α} ∈ CAD^{α}, i=1, . . . , N, α=1, . . . , A. The ID corresponds to choosing the CAD models with texture fields that minimize the distance to the probe:

$$ID = {arg min}_{{CAD}^{α}} {min}_{O , b , {l}^{R} , {l}^{G} , {l}^{B}} {\sum }_{i = 1}^{N} {( {( {Ox}_{i}^{α} + b )}^{t} {Q}_{i} ( {Ox}_{i}^{α} + b ) + ( {ORx}_{i}^{α} ) + b )}^{t} {Q}_{σ ( i )} ( {ORx}_{i}^{α} + b ) ) + {\sum }_{p ∈ {[ 0 , 1 ]}^{2}} {\sum }_{c = R , G , B} {( {I}_{probe}^{c} ( p ) - {ⅇ}^{{\sum }_{i = 1}^{D} {l}_{i}^{c} {ϕ}_{i} ( x ( p ) )} {T}_{{CAD}^{α}}^{c} ( x ( p ) ) )}^{2}$$

For determining ID based on both geometry and texture, any combination of these metrics can be combined, including multiple textured image probes, multiple labeled features without symmetry, unlabeled features in the image plane, labeled features in 3D, unlabeled features in 3D, surface normals in 3D, dense image matching, as well as the different lighting models.

Other embodiments are within the following claims.

What is claimed is:

1. A method of estimating a 3D shape of a target head from at least one source 2D image of the head, the method comprising:
providing a library of candidate 3D avatar models; and searching among the candidate 3D avatar models to locate a best-fit 3D avatar, said searching involving for each 3D avatar model among the library of 3D avatar models computing a measure of fit between a 2D projection of that 3D avatar model and the at least one source 2D image, the measure of fit being based on at least one of (i) a correspondence between feature points in a 3D avatar and feature points in the at least one source 2D image, wherein at least one of the feature points in the at least one source 2D image is unlabeled, and (ii) a correspondence between feature points in a 3D avatar and their reflections in an avatar plane of symmetry, and feature points in the at least one source 2D image, wherein the best-fit 3D avatar is the 3D avatar model among the library of 3D avatar models that yields a best measure of fit and wherein the estimate of the 3D shape of the target head is derived from the best-fit 3D avatar.

2. The method of claim 1, further comprising:
generating a set of notional lightings of the best-fit 3D avatar; searching among the notional lightings of the best-fit avatar to locate a best notional lighting, said searching involving for each notional lighting of the best-fit avatar computing a measure of fit between a 2D projection of the best-fit avatar under that lighting and the at least one source 2D image, wherein the best notional lighting is the lighting that yields a best measure of fit, and wherein an estimate of the lighting of the target head is derived from the best notional lighting.

3. The method of claim 2, wherein the set of notional lightings comprises a set of photometric basis functions and at least one of small and large variations from the photometric basis functions.

4. The method of claim 1, further comprising:
generating a 2D projection of the best-fit avatar;
comparing the 2D projection with each member of a gallery of 2D facial images;and positively identifying the target head with a member of the gallery if a measure of fit between the 2D projection and that member exceeds a pre-determined threshold.

5. The method of claim 1, further comprising:
after locating the best-fit 3D avatar, searching among deformations of the best-fit 3D avatar to locate a best-fit deformed 3D avatar, said searching involving computing the measure of fit between each deformed best-fit avatar and the at least one 2D projection, wherein the best-fit deformed 3D avatar is the deformed 3D avatar model that yields a best measure of fit and wherein the 3D shape of the target head is derived from the best-fit deformed 3D avatar.

6. The method of claim 5, wherein the deformations comprise at least one of small deformations and large deformations.

7. The method of claim 5, further comprising:
generating a set of notional lightings of the deformed best-fit avatar; and
searching among the notional lightings of the best-fit deformed avatar to locate a best notional lighting, said searching involving for each notional lighting of the best-fit deformed avatar computing a measure of fit between a 2D projection of the best-fit deformed avatar under that lighting and the at least one source 2D image, wherein the best notional lighting is the lighting that yields a best measure of fit, and wherein an estimate of the lighting of the target head is derived from the best notional lighting.

8. The method of claim 5, further comprising:
generating a 2D projection of the best-fit deformed avatar;
comparing the 2D projection with each member of a gallery of 2D facial images; and
positively identifying the target head with a member of the gallery if a measure of fit between the 2D projection and that member exceeds a pre-determined threshold.

9. A method of estimating a 3D shape of a target head from at least one source 2D image of the head, the method comprising:
providing a library of candidate 3D avatar models; and searching among the candidate 3D avatar models and among deformations of the candidate 3D avatar models to locate a best-fit 3D avatar, said searching involving, for each 3D avatar model among the library of 3D avatar models and each of its deformations, computing a measure of fit between a 2D projection of that deformed 3D avatar model and the at least one source 2D image, the measure of fit being based on at least one of (i) a correspondence between feature points in a deformed 3D avatar and feature points in the at least one source 2D image, wherein in at least one of the feature points in the at least one source 2D image is unlabeled, and (ii) a correspondence between feature points in a deformed 3D avatar and their reflections in an avatar plane of symmetry, and feature points in the at least one source 2D image, wherein the best-fit deformed 3D avatar is the deformed 3D avatar model that yields a best measure of fit and wherein the estimate of the 3D shape of the target head is derived from the best-fit deformed 3D avatar.

10. The method of claim 9, wherein the deformations comprise at least one of small deformations and large deformations.

11. The method of claim 9, wherein the at least one source 2D projection comprises a single 2D projection and a 3D surface texture of the target head is known.

12. The method of claim 9, wherein the at least one source 2D projection comprises a single 2D projection, a 3D surface texture of the target head is initially unknown, and the measure of fit is based on the degree of correspondence between feature points in the best-fit deformed 3D avatar and their reflections in the avatar plane of symmetry, and feature points in the at least one source 2D image.

13. The method of claim 9, wherein the at least one source 2D projection comprises at least two projections, and a 3D surface texture of the target head is initially unknown.

14. A method of generating a geometrically normalized 3D representation of a target head from at least one source 2D projection of the head, the method comprising:
providing a library of candidate 3D avatar models; and
searching among the candidate 3D avatar models and among deformations of the candidate 3D avatar models to locate a best-fit 3D avatar, said searching involving, for each 3D avatar model among the library of 3D avatar models and each of its deformations, computing a measure of fit between a 2D projection of that deformed 3D avatar model and the at least one source 2D image, the deformations corresponding to permanent and non-permanent features of the target head, wherein the best-fit deformed 3D avatar is the deformed 3D avatar model that yields a best measure of fit; and
generating a geometrically normalized 3D representation of the target head from the best-fit deformed 3D avatar by removing deformations corresponding to non-permanent features of the target head.

15. The method of claim 14, wherein the avatar deformations comprise at least one of small deformations and large deformations.

16. The method of claim 14, further comprising generating a geometrically normalized image of the target head by projecting the normalized 3D representation into a plane corresponding to a normalized pose.

17. The method of claim 16, wherein the normalized pose corresponds to a face-on view.

18. The method of claim 16, further comprising:
comparing the normalized image of the target head with each member of a gallery of 2D facial images having the normal pose; and
positively identifying the target 3D head with a member of the gallery if a measure of fit between the normalized image of the target head and that gallery member exceeds a pre-determined threshold.

19. The method of claim 14, further comprising generating a photometrically and geometrically normalized 3D representation of the target head by illuminating the normalized 3D representation with a normal lighting.

20. The method of claim 19, further comprising generating a geometrically and photometrically normalized image of the target head by projecting the geometrically and photometrically normalized 3D representation into a plane corresponding to a normalized pose.

21. The method of claim 20, wherein the normalized pose is a face-on view.

22. The method of claim 20, wherein the normal lighting corresponds to uniform, diffuse lighting.

23. A method of estimating a 3D shape of a target head from source 3D feature points of the head, the method comprising:
providing a library of candidate 3D avatar models;
searching among the candidate 3D avatar models and among deformations of the candidate 3D avatar models to locate a best-fit deformed avatar, the best-fit deformed avatar having a best measure of fit to the source 3D feature points, the measure of fit being based on a correspondence between feature points in a deformed 3D avatar and the source 3D feature points, wherein the estimate of the 3D shape of the target head is derived from the best-fit deformed avatar.

24. The method of claim 23, wherein the measure if fit is based on a correspondence between feature points in a deformed 3D avatar and their reflections in an avatar plane of symmetry, and the source 3D feature points.

25. The method of claim 23, wherein at least one of the source 3D points is unlabeled.

26. The method of claim 23, wherein at least one of the source 3D feature points are normal feature points, wherein the normal feature points specify a head surface normal direction as well as a position.

27. The method of claim 23, further comprising:
comparing of the best-fit deformed avatar with each member of a gallery of 3D reference representations of heads; and
positively identifying the target 3D head with a member of the gallery of 3D reference representations set if a measure of fit between the best-fit deformed avatar and that member exceeds a pre-determined threshold.

28. A method of estimating a 3D shape of a target head from at least one source 2D image of the head, the method comprising:
providing a library of candidate 3D avatar models; and
searching among the candidate 3D avatar models and among deformations of the candidate 3D avatar models to locate a best-fit deformed avatar, the best-fit deformed avatar having a 2D projection with a best measure of fit to the at least one source 2D image, the measure of fit being based on a correspondence between dense imagery of a projected 3D avatar and dense imagery of the at least one source 2D image, wherein at least a portion of the dense imagery of the projected avatar is generated using a mirror symmetry of the candidate avatars, wherein the estimate of the 3D shape of the target head is derived from the best-fit deformed avatar.

29. A method of positively identifying at least one source image of a target head with a member of a database of candidate facial images, the method comprising:
providing a library of 3D avatar models;
searching among the 3D avatar models and among deformations of the candidate 3D avatar models to locate a source best-fit deformed avatar, the source best-fit deformed avatar having a 2D projection with a best first measure of fit to the at least one source image; for each member of the database of candidate facial images, searching among the library of 3D avatar models and their deformations to locate a candidate best-fit deformed avatar having a 2D projection with a best second measure of fit to the member of the database of candidate facial images;
positively identifying the target head with a member of the database of candidate facial images if a third measure of fit between the source best-fit deformed avatar and the member candidate best-fit deformed avatar exceeds a predetermined threshold.

30. The method of claim 29, wherein the first measure of fit is based at least in part on a degree of correspondence between feature points in the source best-fit deformed avatar and their reflections in the avatar plane of symmetry, and feature points in the at least one source 2D image.

31. The method of claim 29, wherein the second measure of fit is based at least in part on a degree of correspondence between feature points in the candidate best-fit deformed avatar and their reflections in the avatar plane of symmetry, and feature points in the member of the database of candidate facial images.
